(19) United States
(12) Patent Application Publication
(10) Pub. No.: US 2025/0378670 A1
(43) Pub. Date: Dec. 11, 2025

(54) METHODS FOR GENERATING AND EDITING LESION GRAPHICAL REPRESENTATION OF A TARGET BODY PART, AND ASSOCIATED APPARATUS

(71) Applicant: SHENZHEN MINDRAY BIO-MEDICAL ELECTRONICS CO., LTD., Shenzhen (CN)

(72) Inventors: Muqing LIN, Shenzhen (CN); Zixuan CHEN, Shenzhen (CN); Yaoxian ZOU, Shenzhen (CN)

(73) Assignee: SHENZHEN MINDRAY BIO-MEDICAL ELECTRONICS CO., LTD., Shenzhen (CN)

(21) Appl. No.: 19/231,403

(22) Filed: Jun. 6, 2025

(30) Foreign Application Priority Data
Jun. 7, 2024 (CN) 202410745147.7

(51) Int. Cl. G06T 19/20; G06T 7/00

(52) U.S. Cl. CPC G06T 19/20; G06T 7/0012; G06T 2207/30096; G06T 2207/30101; G06T 2219/2004

(57) ABSTRACT

Disclosed are a method for generating a graphical representation of lesion of a target body part, an apparatus, and a computer-readable storage medium, which can generate and display the graphical representation of lesion of the target body part, establishing a new communication tool between users (e.g., sonographers, clinicians) and patients.

### CROSS-REFERENCE TO RELATED APPLICATION

This application claims priority to and the benefit of Chinese Patent Application No. 202410745147.7, filed on Jun. 7, 2024, the disclosure of which is incorporated herein by reference in its entirety.

### TECHNICAL FIELD

The present disclosure relates to the field of medical engineering, in particular to methods for generating a graphical representation of lesion of a target body part, method for editing a graphical representation of lesion, and associated apparatus.

### BACKGROUND OF THE DISCLOSURE

In real clinical practice, many patients exhibit complex diseases that do not conform to the simplified representations found in textbooks. These diseases often involve multiple lesions and exhibit diverse manifestations. A common example is congenital heart disease, which encompasses both single conditions and complex malformations, spanning a wide range of over a hundred specific subtypes and potentially including multiple malformations

Multidisciplinary Team (MDT) consultations are recognized as the most effective way to treat complex diseases. However, due to the fact that medical reports are mostly descriptive text, the descriptions of complex diseases are obscure and difficult to comprehend, making it challenging for doctors to accurately depict the specific details of lesions or malformations in relation to clinical anatomy. In addition, patients frequently lack sufficient clinical knowledge and proper guidance, leading to anxiety and misunderstanding regarding complex diseases. These factors often contribute to ineffective MDT communication, potentially resulting in misdiagnosis.

### SUMMARY OF THE DISCLOSURE

The present disclosure provides a method for generating a graphical representation of lesion of a target body part, a method for editing a graphical representation of lesion, and related apparatuses, as described in detail below.

In an embodiment, a method for generating a graphical representation of lesion of a target body part provided in some embodiments may include:
acquiring a category and an abnormality type of an abnormal anatomical structure in the target body part;
determining a graphical representation of anatomical structure to be loaded according to the category and the abnormality type of the abnormal anatomical structure;
loading the determined graphical representation of anatomical structure;
generating the graphical representation of lesion of the target body part according to the loaded graphical representation of anatomical structure; and
displaying the generated graphical representation of lesion of the target body part.

In some embodiments, said acquiring a category and abnormality type of an abnormal anatomical structure in the target body part may include:
displaying an abnormality selection interface for the anatomical structure of the target body part; and
based on a user operation on the abnormality selection interface, determining the category and the abnormality type of the abnormal anatomical structure of the target body part.

In some embodiments, the abnormality selection interface comprises a plurality of anatomical structure selection items, each corresponding to an anatomical structure of a category and comprising an anatomical structure category name item and at least two type selection items; or, the abnormality selection interface comprises a first quantity of single-malformation selection items and a second quantity of combined-malformation selection items.

In some embodiments, said acquiring a category and abnormality type of an abnormal anatomical structure in the target body part may include:
displaying an input interface;
based on a user input entered through the input interface, acquiring a diagnostic description text regarding the target body part;
inputting the diagnostic description text into a text comprehension model, and processing the diagnostic description text based on the text comprehension model to obtain the category and the abnormality type of the abnormal anatomical structure.

In some embodiments, the target body part is associated with a graphical representation database, wherein the graphical representation database comprises a plurality of graphical representation of anatomical structures of different categories, each category of graphical representation of anatomical structure corresponding to a category of anatomical structure of the target body part; at least one category of graphical representation of anatomical structures comprises a plurality of graphical representation of anatomical structures of a same category but different types, said types at least comprises a normal type and at least one abnormality type, or at least comprises two abnormality types; the item for graphical representation of anatomical structure is configured to represent the category and type of the to-be-loaded graphical representation of anatomical structure in the graphical representation database for the target body part;

said acquiring and loading a to-be-loaded graphical representation of anatomical structure based on the item for graphical representation of anatomical structure may include: based on the item for graphical representation of anatomical structure, acquiring and loading the to-be-loaded graphical representation of anatomical structure from the graphical representation database for the target body part.

In some embodiments, the plurality of graphical representation of anatomical structures of different categories in the graphical representation database comprises: one or more basic category graphical representation of anatomical structures configured to define a complete anatomical structure of the target body part; wherein at least a basic category graphical representation of anatomical structures comprises a plurality of graphical representation of anatomical structures of a same category but different types.

In some embodiments, the target body part comprises a fetal heart or heart, and the basic category graphical representation of anatomical structures comprises at least one of a graphical representation of chamber, a graphical representation of myocardium, a graphical representation of arterial vessel, a graphical representation of valve, and a graphical representation of venous vessel; or, the target body part comprises a blood vessel, and the basic category graphical representation of anatomical structures comprises at least one of a graphical representation of coronary artery, a graphical representation of carotid artery, a graphical representation of abdominal aorta, and a graphical representation of superficial vein.

In some embodiments, the plurality of graphical representation of anatomical structures of different categories in the graphical representation database may further include: at least one special category graphical representation of anatomical structure that is a graphical representation of anatomical structure not present in a normal non-lesioned state of the target body part.

In some embodiments, the target body part comprises a fetal heart or heart, and the special category graphical representation of anatomical structure comprises at least one of a graphical representation of defect, a graphical representation of foramen ovale, and a graphical representation of tumor; or, the target body part comprises blood vessel, and the special category graphical representation of anatomical structure comprises at least one of a graphical representation of plaque, a graphical representation of aneurysm, and a graphical representation of embolism.

In some embodiments, the method for generating the graphical representation of lesion may also include: based on the category and the abnormality type of the abnormal graphical representation of anatomical structure, acquiring an configuration item for graphical representation configured to represent a relative positional relationship of the loaded graphical representation of anatomical structure, wherein at least two different abnormality type are capable of causing the relative positional relationship to differ;

said generating a graphical representation of lesion of the target body part based on the loaded graphical representation of anatomical structure may include: based on the relative positional relationship in the configuration item for graphical representation, combining the loaded graphical representation of anatomical structure to generate the graphical representation of lesion of the target body part.

In some embodiments, the relative positional relationship may include a stacking order of the loaded graphical representation of anatomical structure.

In some embodiments, the method for generating a graphical representation of lesion may also include: acquiring ultrasound data of the target body part; calculating the deformation metrics of the graphical representation of lesion based on the ultrasound data of the target body part and the graphical representation of lesion; and deforming the graphical representation of lesion by using the deformation metrics to obtain a deformed graphical representation of lesion.

In some embodiments, the method for generating a graphical representation of lesion may also include: in response to an editing instruction to the displayed graphical representation of lesion, editing the graphical representation of lesion.

In some embodiments, the method for generating a graphical representation of lesion may also include: determining a graphical representation of anatomical structure that needs to be highlighted in the displayed graphical representation of lesion; and visually highlighting the determined graphical representation of anatomical structure.

In an embodiment, a method for generating a graphical representation of lesion of a target body part provided in some embodiments may include:
acquiring abnormality information of the target body part;
inputting the abnormality information into a generation model that includes an input layer, an intermediate layer and an output layer, wherein the generation model receives the abnormality information via the input layer, extracts features from the received abnormality information via an intermediate layer, generates the graphical representation of lesion of the target body part based on the extracted features, and outputs the graphical representation of lesion of the target body part via the output layer; and
displaying the graphical representation of lesion of the target body part.

In some embodiments, the abnormality information may include a lesion type of the target body part, a category and abnormality type of an abnormal anatomical structure, or a diagnostic description text regarding the target body part.

In some embodiments, said acquiring abnormality information of the target body part may include:
displaying a lesion type selection interface for the target body part, wherein the lesion type selection interface comprises a plurality of lesion type options, each corresponding to a specific lesion type of the target body part; and
in response to an operation on the lesion type selection interface, determining the lesion type of the target body part.

In some embodiments, said acquiring abnormality information of the target body part may include:
displaying an abnormality selection interface for the anatomical structure of the target body part; based on a user operation on the abnormality selection interface, determining a category and abnormality type of an abnormal anatomical structure of the target body part; wherein the abnormality selection interface comprises a plurality of anatomical structure selection items, each corresponding to an anatomical structure of a category and comprising an anatomical structure category name item and at least two type selection items; or the abnormality selection interface comprises a first quantity of single-malformation selection items and a second quantity of combined-malformation selection items;
or, displaying an input interface, acquiring a diagnostic description text regarding the target body part based on a user input entered through the input interface, inputting the diagnostic description text into a text comprehension model, and processing the diagnostic description text based on the text comprehension model to obtain the category and the abnormality type of the abnormal anatomical structure.

In some embodiments, the intermediate layer of the generation model may include a medical text encoding layer, a text-image mapping layer, and an image decoding layer; wherein
the medical text encoding layer is configured to perform word segmentation on the inputted abnormality information, reorganize the segmented text to obtain sentence vectors, and map the sentence vectors into a high-dimensional text encoding spatial feature;
the text-image mapping layer is configured to map the high-dimensional text encoding spatial feature from a text encoding space to an image encoding space to obtain a high-dimensional image encoding spatial feature; and
the image decoding layer is configured to perform image decoding on the high-dimensional image encoding spatial feature to generate the graphical representation of lesion of the target body part.

In some embodiments, the generation model is trained via fine-tuning to upgrade some parameters in the generation model.

In some embodiments, the generation model may be trained by the following:
performing first training only on the medical text encoding layer: training the medical text encoding layer by fine-tuning the inputted abnormality information;
performing second training only on the text-image mapping layer: training the text-image mapping layer by using a text-image pair composed of the abnormality information and corresponding graphical representation of lesion;
performing third training only on the image decoding layer: training the image decoding layer using a mapping relationship from the image encoding space to the graphical representation of lesion;
combining the medical text encoding layer after the first training, the text-image mapping layer after the second training, and the image decoding layer after the third training to obtain the intermediate layer; and
performing fourth training on the combined intermediate layer: fine-tuning the combined intermediate layer using a mapping relationship from the abnormality information to the graphical representation of lesion.

In some embodiments, the generation model may be a large language model.

In some embodiments, the method for generating a graphical representation of lesion may further include: acquiring ultrasound data of the target body part, calculating deformation metrics of the graphical representation of lesion based on the ultrasound data of the target body part and the graphical representation of lesion, and deforming the graphical representation of lesion by using the deformation metrics to obtain a deformed graphical representation of lesion.

In some embodiments, the method for generating a graphical representation of lesion may further include: in response to an editing instruction to the displayed graphical representation of lesion, editing the graphical representation of lesion.

In some embodiments, the generated graphical representation of lesion comprises a plurality of graphical representation of anatomical structures that can be edited individually under the editing instruction.

In some embodiments, the method for generating a graphical representation of lesion may further include: determining a graphical representation of anatomical structure that needs to be highlighted in the displayed graphical representation of lesion; and visually highlighting the determined graphical representation of anatomical structure.

In an embodiment, a method for generating a graphical representation of lesion of a target body part provided in some embodiments may include:
acquiring abnormality information of the target body part;
based on the abnormality information, acquiring a configuration for generating graphical representation configured to represent a first configuration for a category and type of the graphical representation of anatomical structure associated with the abnormality information;
generating a graphical representation of lesion of the target body part at least based on the configuration for generating graphical representation; and
displaying the graphical representation of lesion of the target body part.

In some embodiments, the abnormality information comprises a lesion type of the target body part, a category and abnormality type of an abnormal anatomical structure, or a diagnostic description text regarding the target body part.

In some embodiments, said acquiring abnormality information of the target body part comprises:
displaying a lesion type selection interface for the target body part, wherein the lesion type selection interface comprises a plurality of lesion type options, each corresponding to a specific lesion type of the target body part; and
in response to an operation on the lesion type selection interface, determining the lesion type of the target body part.

In some embodiments, said acquiring abnormality information of the target body part may comprise:
displaying an abnormality selection interface for the anatomical structure of the target body part; based on a user operation on the abnormality selection interface, determining a category and abnormality type of an abnormal anatomical structure of the target body part; wherein the abnormality selection interface comprises a plurality of anatomical structure selection items, each corresponding to an anatomical structure of a category and comprising an anatomical structure category name item and at least two type selection items; or the abnormality selection interface comprises a first quantity of single-malformation selection items and a second quantity of combined-malformation selection items;
or, acquiring a diagnostic description text regarding the target body part, inputting the diagnostic description text into a text comprehension model, and processing the diagnostic description text based on the text comprehension model to obtain the category and the abnormality type of the abnormal anatomical structure.

In some embodiments, the target body part is associated with a graphical representation database, wherein the graphical representation database comprises a plurality of anatomical structures with different categories, the anatomical structures of at least an category comprises a plurality of anatomical structures of the same category but different types, said types at least comprising a normal type and at least one abnormality type, or at least comprising two abnormality types; the configuration for generating graphical representation comprises a first configuration for representing the category and type of the anatomical structure associated with the abnormality information in the database for the target body part;
said generating the graphical representation of lesion of the target body part at least based on the configuration for generating graphical representation comprises: based on the configuration for generating graphical representation and the graphical representation database, generating the graphical representation of lesion of the target body part.

In some embodiments, the plurality of graphical representation of anatomical structures of different categories in the graphical representation database comprises one or more basic category graphical representation of anatomical structures, each category of graphical representation of anatomical structure corresponding to the category of anatomical structure of the target body part; wherein the basic category graphical representation of anatomical structure is configured to define a complete anatomical structure of the target body part, and at least a basic category graphical representation of anatomical structures comprises a plurality of graphical representation of anatomical structures of the same category but different types.

In some embodiments, the target body part may include a fetal heart or heart, and the basic category graphical representation of anatomical structures may include at least one of a graphical representation of chamber, a graphical representation of myocardium, a graphical representation of arterial vessel, a graphical representation of valve, and a graphical representation of venous vessel; or, the target body part may include a blood vessel, and the basic category graphical representation of anatomical structures may include at least one of a graphical representation of coronary artery, a graphical representation of carotid artery, a graphical representation of abdominal aorta, and a graphical representation of superficial vein.

In some embodiments, the plurality of graphical representation of anatomical structures of different categories in the graphical representation database may also include: at least one special category graphical representation of anatomical structure that is a graphical representation of anatomical structure not present in a normal non-lesioned state of the target body part.

In some embodiments, the target body part may include a fetal heart or heart, and the special category graphical representation of anatomical structure may include at least one of a graphical representation of defect, a graphical representation of foramen ovale, and a graphical representation of tumor; or, the target body part may include a blood vessel, and the special category graphical representation of anatomical structure may include at least one of a graphical representation of plaque, a graphical representation of aneurysm, and a graphical representation of embolism.

In some embodiments, the configuration for generating graphical representation may also include a second configuration for representing the relative positional relationship of the graphical representation of anatomical structures of respective categories in the first configuration.

In some embodiments, the relative positional relationship may include a stacking order of the graphical representation of anatomical structures of respective categories in the first configuration when generating the graphical representation of lesion.

In some embodiments, said acquiring a configuration for generating graphical representation based on the abnormality information may include: selecting one configuration for generating graphical representation from a plurality of different configuration for generating graphical representations based on the abnormality information.

In some embodiments, said generating the graphical representation of lesion of the target body part based on the configuration for generating graphical representation and the graphical representation database may include:
based on the first configuration, selecting the graphical representation of anatomical structure of corresponding category and type from the graphical representation database; and
generating the graphical representation of lesion based on the selected graphical representation of anatomical structure.

In some embodiments, said generating the graphical representation of lesion based on the selected graphical representation of anatomical structure may include: combining the selected graphical representation of anatomical structure based on the second configuration to generate the graphical representation of lesion.

In some embodiments, the method for generating a graphical representation of lesion may also include: acquiring ultrasound data of the target body part; calculating deformation metrics of the graphical representation of lesion based on the ultrasound data of the target body part and the graphical representation of lesion; and deforming the graphical representation of lesion by using the deformation metrics to obtain a deformed graphical representation of lesion.

In some embodiments, the method for generating a graphical representation of lesion may also include: in response to an editing instruction to the displayed graphical representation of lesion, editing the graphical representation of lesion.

In some embodiments, the method for generating a graphical representation of lesion may also include: determining a graphical representation of anatomical structure that needs to be highlighted in the displayed graphical representation of lesion; and visually highlighting the determined graphical representation of anatomical structure.

In an embodiment, a method for editing a graphical representation of lesion of a target body part provided in some embodiments may include:
displaying the graphical representation of lesion of the target body part, wherein the graphical representation of lesion comprises a plurality of graphical representation of anatomical structures that are editable individually; and
receiving an editing instruction to the graphical representation of lesion and editing the graphical representation of lesion.

In some embodiments, said receiving an editing instruction to the graphical representation of lesion and editing the graphical representation of lesion may include:
receiving an editing instruction to the graphical representation of lesion;
parsing the editing instruction to determine a to-be-edited graphical representation of anatomical structure and an editing content; and
editing the to-be-edited graphical representation of anatomical structure based on the editing content.

In some embodiments, said editing the graphical representation of lesion may include at least one of the following:
adding one or more graphical representation of anatomical structures in the graphical representation of lesion;
deleting one or more graphical representation of anatomical structures contained in the graphical representation of lesion; and
editing the morphology and/or position of one or more graphical representation of anatomical structures contained in the graphical representation of lesion.

In some embodiments, receiving an editing instruction to the graphical representation of lesion and editing the graphical representation of lesion may include:
receiving a selection instruction for selecting a graphical representation of anatomical structure in the graphical representation of lesion;
determining a target graphical representation of anatomical structure to be adjusted in the graphical representation of lesion according to the received selection instruction;
receiving an adjustment instruction; and
adjusting at least one of a position, a shape, a size, a direction and a thickness of the target graphical representation of anatomical structure to be adjusted according to the adjustment instruction.

In some embodiments, the graphical representation of lesion includes a graphical representation of vessel, and said receiving an editing instruction to the graphical representation of lesion and editing the graphical representation of lesion may include:
determining a first position in the graphical representation of vessel of the graphical representation of lesion, and adding a graphical representation of vascular branch at the first position in the graphical representation of lesion;
or,
determining a first position in the graphical representation of vessel of the graphical representation of lesion, determining a second position in the graphical representation of vessel of the graphical representation of lesion, and adding a graphical representation of bridging vessel connecting the first position and the second position in the graphical representation of lesion according to the first position and the second position.

In some embodiments, the target body part may include a fetal heart or heart; and said adding one or more graphical representation of anatomical structures in the graphical representation of lesion may include at least one of the following:
adding a graphical representation of vascular branch in the graphical representation of lesion;
adding a graphical representation of bridging vessel in the graphical representation of lesion;
adding a graphical representation of tumor in the graphical representation of lesion; and
adding a graphical representation of defect in the graphical representation of lesion.

In some embodiments, the target body part may include a fetal heart or heart; and said editing the morphology and/or position of one or more graphical representation of anatomical structures contained in the graphical representation of lesion may include at least one of the following:
editing a diameter of an entire or partial graphical representation of vessel in the graphical representation of lesion;
editing a dimension, position and/or orientation of a graphical representation of tumor in the graphical representation of lesion;
editing a size of a graphical representation of atrial or graphical representation of ventricular in the graphical representation of lesion;
editing a wall thickness of a graphical representation of atrial or graphical representation of ventricular in the graphical representation of lesion;
editing a size of a graphical representation of arterial valve in the graphical representation of lesion;
editing an opening size of a graphical representation of mitral valve or graphical representation of tricuspid valve in the graphical representation of lesion;
editing a thickness of a graphical representation of mitral valve or graphical representation of tricuspid valve in the graphical representation of lesion;
editing a thickness of a graphical representation of arterial cone in the graphical representation of lesion; and
editing the stacking order of the graphical representation of anatomical structure in the graphical representation of lesion.

In some embodiments, the graphical representation of anatomical structure added to the graphical representation of lesion may be acquired from the graphical representation database for the target body part; the graphical representation database comprises a plurality of graphical representation of anatomical structures of different categories, each category of graphical representation of anatomical structure corresponding to a category of anatomical structure of the target body part; at least one category of graphical representation of anatomical structures may include a plurality of graphical representation of anatomical structures of a same category but different types, said types at least comprise a normal type and at least one abnormality type.

In some embodiments, the graphical representation of lesion is generated by the method for generating a graphical representation of lesion mentioned in any one of embodiments disclosed herein.

In an embodiment, an apparatus for a graphical representation of lesion of a target body part provided in some embodiments may include:
a memory for storing a program; and
a processor for executing the program stored in the memory to implement the method mentioned in any one of embodiments disclosed herein.

In an embodiment, a computer-readable medium may include a program executable by a processor to implement the method mentioned in any one of embodiments disclosed herein.

The methods, apparatus, and computer-readable storage medium for generating a graphical representation of lesion of a target body part according to the above embodiments can generate and display the graphical representation of lesion of the target body part, thereby establishing a novel communication bridge between users (e.g., ultrasound physicians and clinicians, etc.) and patients.

The methods, apparatus, and computer-readable storage media for editing a graphical representation of lesion of a target body part according to the above embodiments allows users to edit the generated graphical representation of lesion of the target body part, such as addition, deletion, and/or adjustment of the graphical representation of anatomical structure, thereby significantly enhancing the applicability of the graphical representation of lesion.

### BRIEF DESCRIPTION OF THE DRAWINGS

FIG. 1 is a flowchart of a method for generating a graphical representation of lesion of a target body part in some embodiments;

FIG. 2 is a structural schematic diagram of an ultrasound imaging system in some embodiments;

FIG. 3 is a flowchart illustrating acquisition of a target lesion type of a target body part in some embodiments;

FIG. 4A is a schematic diagram of a lesion type selection interface in some embodiments;

FIG. 4B is a schematic diagram of a lesion type selection interface in some embodiments;

FIG. 5 is a schematic diagram illustrating an abnormality type 1 and an abnormality type 2 of a superior vena cava in some embodiments;

FIG. 6 is a flowchart for obtaining a category and abnormality type of an abnormal anatomical structure in some embodiments;

FIG. 7 is a flowchart for obtaining a category and abnormality type of an abnormal anatomical structure in some embodiments;

FIG. 8A is a schematic diagram of an abnormality selection interface for the anatomical structure of the target body part in some embodiments;

FIG. 8B is a schematic diagram of an abnormality selection interface for the anatomical structure of the target body part in some embodiments;

FIG. 9 is a flowchart for generating a graphical representation of lesion based on the abnormality information of the target body part and utilizing the graphical representation database for the target body part in some embodiments;

FIG. 10 is a flowchart for generating a graphical representation of lesion based on the abnormality information of the target body part and utilizing the graphical representation database for the target body part in some embodiments;

FIG. 11 is a schematic diagram of a generated graphical representation of lesion in some embodiments;

FIG. 12 is a schematic diagram of a generated graphical representation of lesion in some embodiments;

FIG. 13 is a schematic diagram illustrating shared and distinct graphical representation of anatomical structures between a graphical representation of lesion for a Type 1 persistent left superior vena cava and a graphical representation of lesion for a Type 2 persistent left superior vena cava in some embodiments;

FIG. 14 is a structural schematic diagram of a generated model in some embodiments;

FIG. 15 is a structural schematic diagram of a generated model in some embodiments;

FIG. 16 is a flowchart of a method for generating a graphical representation of lesion of a body part in some embodiments;

FIG. 17 is a flowchart of a method for generating a graphical representation of lesion of a body part in some embodiments;

FIG. 18 is a flowchart of a method for editing a graphical representation of lesion of a target body part in some embodiments;

FIG. 19 is a flowchart illustrating receiving an editing instruction for a graphical representation of lesion and editing the graphical representation of lesion in some embodiments;

FIG. 20 is a schematic diagram of adding a graphical representation of bridging vessel in some embodiments;

FIG. 21 is a schematic diagram of adding a graphical representation of vascular branch in some embodiments;

FIG. 22 is a schematic diagram of adding a graphical representation of defect in some embodiments;

FIG. 23 is a schematic diagram of adding a graphical representation of tumor in some embodiments;

FIG. 24 is a schematic diagram illustrating editing a diameter of a partial graphical representation of vessel in some embodiments;

FIG. 25 is a schematic diagram illustrating editing a diameter of an entire graphical representation of vessel in some embodiments;

FIG. 26 is a schematic diagram illustrating editing a graphical representation of tumor in some embodiments;

FIG. 27 is a schematic diagram illustrating editing a graphical representation of defect in some embodiments;

FIG. 28 is a schematic diagram illustrating editing a graphical representation of atrial, a graphical representation of ventricular, and a wall thickness thereof in some embodiments;

FIG. 29 is a schematic diagram illustrating editing a graphical representation of arterial valve in some embodiments;

FIG. 30 is a schematic diagram illustrating editing a mitral valve and graphical representation of tricuspid valve in some embodiments;

FIG. 31 is a schematic diagram illustrating editing a graphical representation of arterial cone in some embodiments;

FIG. 32 is a schematic diagram illustrating editing a stacking order in some embodiments;

FIG. 33 is a schematic diagram illustrating replacement of a graphical representation of anatomical structure in some embodiments;

FIG. 34 is a schematic diagram illustrating deletion of a graphical representation of anatomical structure in some embodiments; and

FIG. 35 is a structural schematic diagram of a graphical representation of lesion apparatus for a target body part in some embodiments.

### DETAILED DESCRIPTION

Specific embodiments of the present disclosure will now be described in detail with reference to the accompanying drawings. Similar or related components in different embodiments are labeled with associated reference numerals. The following embodiments include detailed descriptions to facilitate understanding of the present disclosure. However, those skilled in the art will readily recognize that certain features may be omitted under specific circumstances or substituted by other components, materials, or methods. In some instances, certain operations related to the present disclosure are not explicitly described or illustrated herein. This intentional exclusion is intentional to avoid obscuring the core technical solutions of the present disclosure. For those skilled in the art, a complete understanding of these operations can be attained through the descriptions provided in this specification and general technical knowledge in the art.

Additionally, the features, operations, or characteristics described in the specification may be combined in any suitable manner to form various embodiments. Similarly, steps or actions in the method descriptions may be reordered or modified in ways that would be obvious to those skilled in the art. Therefore, the sequences presented in the specification and drawings are intended solely to clarify the description of specific embodiments and do not imply mandatory orderings, unless explicitly stated that a particular sequence is required.

The numerical designations assigned to components in this specification, such as ‘first,’ ‘second,’ or similar ordinal terms, serve solely to distinguish described objects and carry no inherent sequential or technical implications. Furthermore, the terms ‘connected’ and ‘coupled’ as used herein encompass both direct and indirect connection (coupling), unless explicitly stated otherwise.

Firstly, due to the complex lesion structures in many parts of patients, doctors need considerable experience to diagnose lesion sites through ultrasound images, as they must clearly correlate ultrasound images and parameters with clinical anatomy.

Secondly, some complex diseases have intricate physiological and anatomical relationships, making it challenging to describe the specific conditions of lesion or malformation sites. This may lead to ineffective communication in multidisciplinary team (MDT) settings and may cause misdiagnosis.

Thirdly, medical reports (e.g., ultrasound reports) rely on textual descriptions that are often abstruse, particularly for complex diseases. Such descriptions hinder physicians' ability to effectively convey disease-related information to patients.

In some existing approaches, doctors may attempt to describe diseases by manually sketching anatomical structures of pathological regions in the target body part. However, such hand-drawn illustrations impose stringent requirements on both the doctors' drafting proficiency and their comprehensive understanding of diverse pathologies. Furthermore, the manual sketching process is inherently time-consuming, rendering it exceptionally rare for doctors to generate accurate hand-depicted representations of complex diseases.

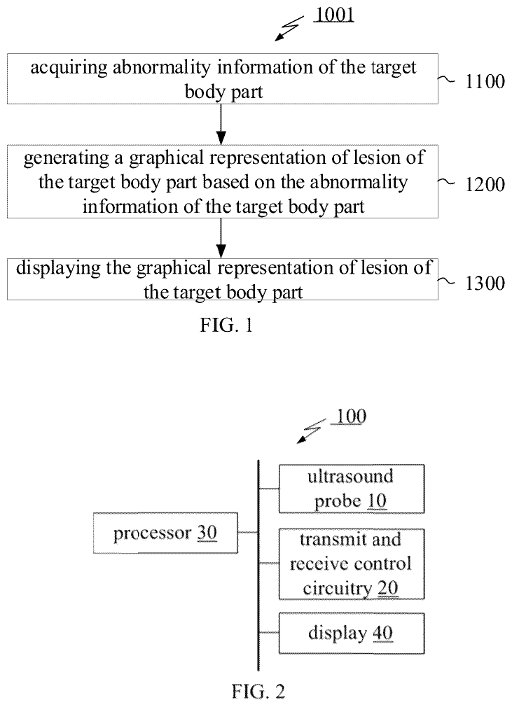

As shown in FIG. 1, a method 1001 for generating a graphical representation of lesion of a target body part provided in some embodiments may comprise the following steps:

Step 1100: acquiring abnormality information of the target body part.

In some examples, the abnormality information may include one or more of the following: (1) the lesion type of the target body part; (2) diagnostic description language text regarding the target region; (3) the category and abnormality type of an abnormal anatomical structure. Detailed explanations are provided below.

### (1) Acquisition of the Lesion Type of the Target Body Part.

Step 1100 can acquire the lesion type of the target body part in various ways, such as automatically or manually.

Step 1100 may implement automated identification of the lesion type of the target body part via techniques including, but not limited to, machine learning. For example, Step 1100 may input ultrasound data of the target body part into a lesion type recognition model to determine the target lesion type. The recognition model for the target lesion type is configured to take ultrasound data of the target body part as input and output the lesion type of the target body part after processing. In some embodiments, the lesion type recognition model comprises at least one of the following: a convolutional neural network (CNN)-based model; a recurrent neural network (RNN)-based model; a generative adversarial network (GAN)-based model; an attention-based neural network model; and a fully connected network-based model.

It is noted that ultrasound data is acquired based on ultrasound imaging technology. Ultrasound imaging technology involves scanning human tissues and organs using ultrasonic waves and acquiring images of corresponding regions by receiving and processing reflected signals.

For example, FIG. 2 illustrates an exemplary ultrasound imaging system 100, which may include: an ultrasound probe 10; a transmit and receive control circuitry 20; and a processor 30. In some embodiments, the ultrasound imaging system 100 may further comprise a display 40. Below is a description of these components.

In some embodiments, the ultrasound probe 10 is configured to transmit ultrasound waves and receive corresponding echo signals. In specific implementations, the ultrasound probe 10 comprises a plurality of transducer elements to enable mutual conversion between electrical pulse signals and ultrasonic waves, thereby facilitating the transmission of ultrasound waves to a target region and the reception of ultrasonic echoes reflected by biological tissues to acquire echo signals. In certain embodiments, the plurality of transducer elements in the ultrasound probe 10 may be arranged in a linear array (i.e., a one-dimensional row). In other embodiments, the transducer elements may be arranged in a two-dimensional matrix to form a planar array. The transducer elements may comprise, for example, piezoelectric crystals, which convert electrical signals into ultrasonic signals based on a transmission sequence provided by the transmit and receive control circuitry 20. Depending on the application, the transmitted ultrasound waves (ultrasonic signals) may include one or more of the following: scanning pulses, reference pulses, push pulses, and/or Doppler pulses. Based on wave morphology, the ultrasonic signals may include focused waves, plane waves, or diverging waves. Each transducer element is configured to transmit ultrasound waves in response to excitation electrical signals or convert received ultrasound waves into electrical signals. Thus, each transducer element enables bidirectional conversion between electrical pulses and ultrasound waves, allowing both transmission of ultrasound waves to the target region and reception of echo signals reflected by tissues. During ultrasound imaging, the transmit and receive control circuitry 20 determines: which transducer elements act as transmitting elements to emit ultrasound beams, which transducer elements act as receiving elements to capture reflected echoes, or controls elements to alternate between emission and reception in timed intervals. Transmitting elements can be excited simultaneously by electrical signals to emit ultrasound waves concurrently, or sequentially with time intervals to produce pulsed emissions. If the smallest region in the target region that receives and reflects ultrasound waves is called a tissue location point, then after the ultrasound waves reach each location point in the target region, different reflections may be produced due to the different acoustic impedances of the tissues at these points. The reflected ultrasound waves are captured by receiving elements. Each receiving element may receive echoes from multiple location points, and the echoes from different points received by each element form distinct channel echo data. For a given receiving element, the distance to different location points in the target region varies. Therefore, the time it takes for echoes from these points to reach the element also differs. This time difference allows for the identification of the correspondence between the received echoes and the tissue location points.

The transmit and receive control circuitry 20 is configured to control the ultrasound probe 10 for both ultrasonic wave transmission and echo signal reception. For example, the transmit and receive control circuitry 20 controls the ultrasound probe 10 to emit ultrasound waves toward the target region and receive ultrasound echoes reflected by biological tissues. In some embodiments, the transmit and receive control circuitry 20 is configured to generate a transmission sequence and a reception sequence, which are output to the ultrasound probe 10. The transmission sequence is configured to control part or all transducer elements within the ultrasound probe 10 to emit ultrasound waves toward the target region. Parameters of the transmission sequence may include: number of activated transmitting elements; and ultrasound wave emission parameters (e.g., pulse amplitude, transmit voltage, emission frequency, pulse repetition count, emission interval, beam steering angle, waveform, transmit aperture, line density, point density, and/or focal position). The reception sequence is configured to control part or all transducer elements to receive echoes resulting from tissue-reflected ultrasonic waves. Parameters of the reception sequence may include: number of activated receiving elements; and echo reception parameters (e.g., reception angle, imaging depth). The ultrasound wave parameters in the transmission sequence and the echo reception parameters in the reception sequence vary depending on the intended application of the ultrasound echoes or the type of image generated from the echoes.

The processor 30 is configured to process ultrasound echo signals (i.e., echo signals of the ultrasound waves) received by the ultrasound probe 10. This processing may involve one or more stages of signal conditioning applied to the ultrasonic echo signals or channel-specific echo data, such as: analog-to-digital conversion; signal demodulation; amplification; filtering; downsampling; beamforming; envelope detection; logarithmic compression; and/or grayscale mapping. By processing the ultrasonic echo signals, the processor 30 ultimately generates ultrasound images for display on the display 40.

In some embodiments, the processor 30 may comprise, but not limited to, a central processing unit (CPU), a microcontroller unit (MCU), a field-programmable gate array (FPGA), and a digital signal processor (DSP), configured to execute computer instructions and process data within computer software.

The above describes some aspects of the ultrasound imaging system 100. In some embodiments of this application, the ultrasound imaging system 100 can perform methods described in any of the embodiments herein, such as the graphical representation of lesion generation method 1001 and the graphical representation of lesion editing method 1401 mentioned herein.

As mentioned above, step 1100 may also manually obtain the lesion type of the target body part. As shown in FIG. 3, in some embodiments, step 1100 includes:

Step 1101: displaying a lesion type selection interface for the target body part.

Step 1102: in response to an operation on the lesion type selection interface, determining the lesion type of the target body part.

In some examples, the lesion type selection interface comprises a plurality of lesion type options, each corresponding to a specific lesion type of the target body part.

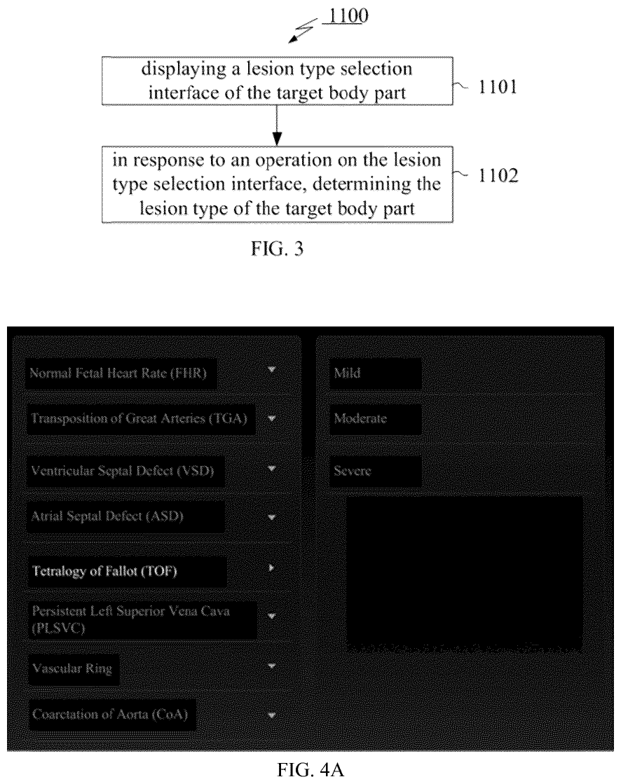

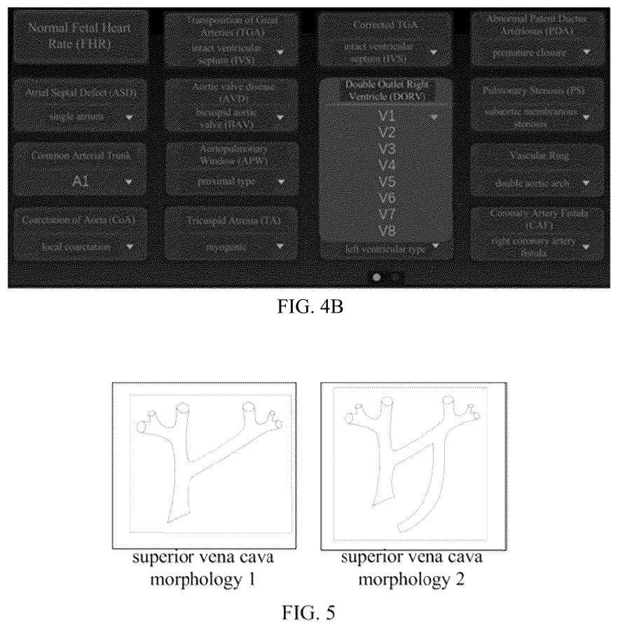

FIGS. 4A and 4B illustrate two examples of the lesion type selection interface for the target body part displayed when the target body part comprises a heart. In clinical practice, after determining structural malformations and their severity in a patient's heart via echocardiography, doctors may diagnose congenital heart disease (CHD) (i.e., identifying the target lesion type of the target body part). Following diagnosis, doctors may utilize the illustrated lesion type selection interface to select the specific CHD and its corresponding subtype, thereby enabling the selection of the cardiac lesion type via the interface.

### (2) Acquisition of Diagnostic Description Language Text for the Target Body Part

The diagnostic description language text for the target body part comprises textual descriptions of diagnostic information related to the target body part. This text may be acquired by providing an input tool and/or an input interface for user input.

### (3) Acquisition of the Category and Abnormality Type of an Abnormal Anatomical Structure

The category and abnormality type of an abnormal anatomical structure are distinct from the concept of a lesion type. Lesion type refers to the type of disease diagnosed in the target body part or the patient. In contrast, the category of an abnormal anatomical structure refers to which anatomical structures within the target body part are abnormal, and the abnormality type of an abnormal anatomical structure refers to the different forms these abnormalities may take, with each form representing a specific abnormality type.

For example, the target body part may be divided into multiple anatomical structures that collectively form a complete anatomical structure of the target body part. Assume the target body part includes three anatomical structures: Anatomical Structure A, Anatomical Structure B, and Anatomical Structure C, thereby comprising three categories of anatomical structures: Category A, Category B, and Category C. When the target body part develops a lesion, there may be various kinds of lesions, which can be classified as different lesion types. When a lesion occurs, one or more anatomical structures within the target body part may exhibit abnormal morphological characteristics (e.g., deviations from normal morphology). At this point, it is necessary to identify which categories of anatomical structures are abnormal. Moreover, the form of abnormality of the same anatomical structure may also vary. For instance, an anatomical structure may be abnormally small or abnormally large. Therefore, the abnormality type of an anatomical structure may include one or more variations. Additionally, anatomical structures may exhibit a normal type (i.e., non-abnormal morphology). Thus, for the same category of anatomical structure, its type may include a normal type and one or more abnormality types.

For example, when the target body part comprises a heart, the target body part may include various anatomical structures such as chambers, myocardium, arteries, valves, and veins. Specifically, chambers may be further divided into the left and right atria and ventricles; arteries may be subdivided into the aorta, pulmonary artery and its branches, arterial cone, and ductus arteriosus; and veins may be subdivided into the superior and inferior vena cava, pulmonary veins, and innominate veins. These anatomical structures may be categorized based on clinical or user requirements. For example, the superior vena cava (a specific anatomical structure category) may exhibit different types of abnormalities, such as abnormality type 1 and abnormality type 2 shown in FIG. 5.

There are various ways to obtain the category and abnormality type of an abnormal anatomical structure of the target body part in step 1100, such as automatic, semi-automatic, or manual methods.

In some embodiments, step 1100 may automatically identify the category and abnormality type of an abnormal anatomical structure of the target body part from the ultrasound data of the target body part by using machine learning or similar techniques.

In other embodiments, Step 1100 may derive the category and abnormality type of an abnormal anatomical structure of the target body part from the diagnostic description text about the target body part by using a text comprehension model.

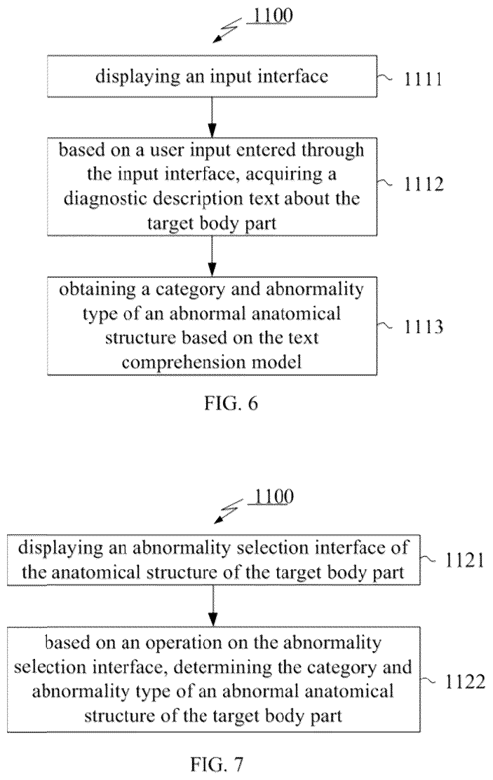

For example, step 1100 first obtains a diagnostic description text about the target body part (which may be input by a user via an input tool), then inputs the diagnostic description text into a text comprehension model and processes the diagnostic description text based on the text comprehension model to obtain the category and abnormality type of an abnormal anatomical structure. As shown in FIG. 6, the acquisition of the category and abnormality type of an abnormal anatomical structure in step 1100 may be implemented as follows:
Step 1111: displaying an input interface;
Step 1112: based on a user input entered through the input interface, acquiring a diagnostic description text about the target body part; and
Step 1113: obtaining a category and abnormality type of an abnormal anatomical structure based on the text comprehension model. Specifically, in step 1113, the diagnostic description text is inputted into a text comprehension model; and the diagnostic description text is processed based on the text comprehension model to obtain the category and abnormality type of an abnormal anatomical structure.

As shown in FIG. 7, the category and abnormality type of an abnormal anatomical structure obtained in step 1100 in some embodiments may include the following steps:
Step 1121: displaying an abnormality selection interface for the anatomical structure of the target body part; and
Step 1122: based on an operation on the abnormality selection interface, determining the category and abnormality type of an abnormal anatomical structure of the target body part.

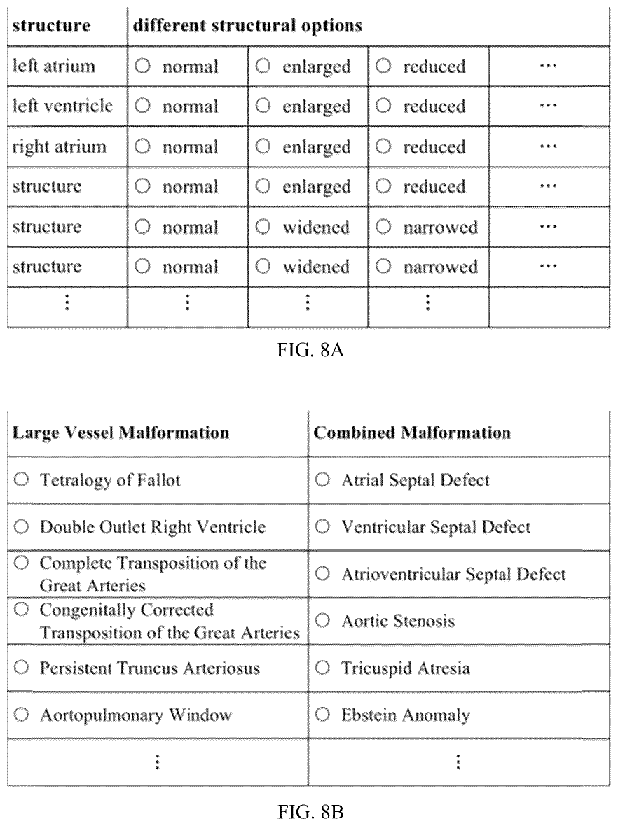

In some examples, the abnormality selection interface comprises multiple anatomical structure selection items, each corresponding to an anatomical structure of a category. Each anatomical structure selection item includes an anatomical structure category name item and at least two type selection items, as exemplified in FIG. 8A. Accordingly, in response to a user's selection of a category and type of an anatomical structure, the category and abnormality type of an abnormal anatomical structure of the target body part are determined. It should be noted that in FIG. 8A, entries such as left atrium, left ventricle, right atrium, right ventricle, aorta, and pulmonary artery represent anatomical structure category name items; while options such as normal, enlarged, reduced, widened, and narrowed under different structural options represent type selection items.

In some examples, the abnormality selection interface comprises a first quantity of single-malformation selection items and a second quantity of combined-malformation selection items, as exemplified in FIG. 8B. Accordingly, in response to a user's selection of single-malformation selection items and/or combined-malformation selection items, the category and abnormality type of an abnormal anatomical structure of the target body part are determined. It should be noted that in FIG. 8B, “Large Vessel Malformation” refers to a directory of single-malformation selection items.

Furthermore, in some examples, step 1110 involves acquiring single malformation information and combined malformation information for the target body part to determine the category and abnormality type of an abnormal anatomical structure of the target body part.

The above provides some explanations regarding step 1100 of acquiring abnormality information of the target body part.

Step 1200: generating a graphical representation of lesion of the target body part based on the abnormality information of the target body part. The following provides specific details.

In some embodiments, step 1200 involves generating the graphical representation of lesion by utilizing the abnormality information of the target body part and the graphical representation database for the target body part. First, the graphical representation database for the target body part is described.

In some embodiments, the target body part is associated with a graphical representation database which includes one or more graphical representation of anatomical structures of different categories. Each category of graphical representation of anatomical structure corresponds to a category of anatomical structure of the target body part. For example, as mentioned earlier, the target body target may be divided into multiple anatomical structures that together form a complete anatomical structure of the target body part. Assume the target body part includes three anatomical structures: Anatomical Structure A, Anatomical Structure B, and Anatomical Structure C, thereby comprising three categories of anatomical structures: Category A, Category B, and Category C. Accordingly, the graphical representation database for the target body part may include three categories of graphical representation of anatomical structures: Graphical representation of anatomical structure A, Graphical representation of anatomical structure B, and Graphical representation of anatomical structure C; wherein Graphical representation of anatomical structure A corresponds to Category A of the target body part, Graphical representation of anatomical structure B corresponds to Category B of the target body part, and Graphical representation of anatomical structure C corresponds to Category C of the target body part. For instance, if the target body part is the heart, it may include various categories of anatomical structures such as chambers, myocardium, arteries, valves, and veins. Consequently, the graphical representation database for the target body part may include various categories of graphical representation of anatomical structures, such as a graphical representation of chamber, a graphical representation of myocardium, a graphical representation of arterial vessel, a graphical representation of valve, and a graphical representation of venous vessel.

In some examples, at least one category of graphical representation of anatomical structures includes a plurality of graphical representation of anatomical structures of a same category but different types. In some examples, different types include at least two types, such as two abnormality types, such as a normal type and at least one abnormality type, etc. As mentioned above, anatomical structures of the same category may exhibit multiple types, such as a normal type and one or more abnormality types. Accordingly, different types of graphical representation of anatomical structures of the same category correspond to different types of the same category of that anatomical structure. For instance, consider the superior vena cava as a category of anatomical structure. It may include Abnormality Type 1 and Abnormality Type 2 of the superior vena cava, as illustrated in FIG. 5. In this case, the graphical representation of superior vena cava corresponds to the superior vena cava category, and this category may include two types of graphical representation of superior vena cavas, each corresponding to a different subtype of the anatomical structure within the same category (e.g., Abnormality Type 1 and Abnormality Type 2).

In some embodiments, the graphical representation of anatomical structures of one or more different categories in the graphical representation database comprises: one or more basic category graphical representation of anatomical structures. In some examples, a basic category graphical representation of anatomical structures is configured to define a complete anatomical structure of the target body part. In some examples, at least a basic category graphical representation of anatomical structures comprises a plurality of graphical representation of anatomical structures of a same category but different types. In some examples, different types at least comprise two types, such as at least two abnormality types, or a normal type and at least one abnormality type.

The graphical representation database for the target body part may include basic category graphical representation of anatomical structures (i.e., the specific categories and quantities of the graphical representation of anatomical structures), which can be determined by the structural division of the target body part based on clinical or user requirements. Additionally, for any specific basic category graphical representation of anatomical structure, whether it includes only one type or multiple types of graphical representation of anatomical structures in the graphical representation database, and the specific type of each (normal type or abnormality type, and if abnormal, the specific type of abnormality), can also be designed based on clinical or user requirements.

In general, the basic category graphical representation of anatomical structures may be derived from the anatomical division of the target body part based on medical anatomical common knowledge. Therefore, these basic category graphical representation of anatomical structures can be used to define the complete anatomical structure of the target body part.

Additionally, when the target body part may also include a special graphical representation of anatomical structure that is not present in a normal non-lesioned state of the anatomical structure of the target body part. Accordingly, in some examples, one or more graphical representation of anatomical structures of different categories in the graphical representation database may also include: at least one special category graphical representation of anatomical structure that is not present in a normal non-lesioned state of the anatomical structure of the target body part.

In some examples, the target body part comprises a fetal heart or heart, and the basic category graphical representation of anatomical structures include at least one of a graphical representation of chamber (left and right atrial and graphical representation of ventricular), a graphical representation of myocardium, a graphical representation of arterial vessel (graphical representations of aorta, pulmonary artery and their branches, graphical representation of conus arteriosus, graphical representation of ductus arteriosus, etc.), a graphical representation of valve (graphical representations of mitral valve, tricuspid valve, aortic valve, and pulmonary valves), and a graphical representation of venous vessel (graphical representation of superior vena cava, graphical representation of inferior vena cava, graphical representation of pulmonary vein, graphical representation of innominate vein, etc.). In some examples, the special category graphical representation of anatomical structure may include at least one of a graphical representation of defect, a graphical representation of foramen ovale, and a graphical representation of tumor.

In some examples, the target body part includes blood vessel, the basic category graphical representation of anatomical structures includes at least one of a graphical representation of coronary artery, a graphical representation of carotid artery, a graphical representation of abdominal aorta, and a graphical representation of superficial vein. In some examples, the special category graphical representation of anatomical structure includes at least one of a graphical representation of plaque, a graphical representation of aneurysm, and a graphical representation of embolism.

Consequently, from another perspective, in some embodiments, the graphical representation database for the target body part may include N different basic category graphical representation of anatomical structures, which collectively define the complete/universal anatomical structure of the target body part. In some examples, at least one of the N different basic category graphical representation of anatomical structures includes one or more abnormality types. In some examples, at least one of the N different basic category graphical representation of anatomical structures includes both abnormal and normal types. In some examples, at least one of the N different basic category graphical representation of anatomical structures includes a normal type. In some embodiments, the graphical representation database for the target body part may further include M special category graphical representation of anatomical structures that correspond to anatomical structures not present in a normal non-lesioned target body part.

The above provides some descriptions of the graphical representation database for the target region.

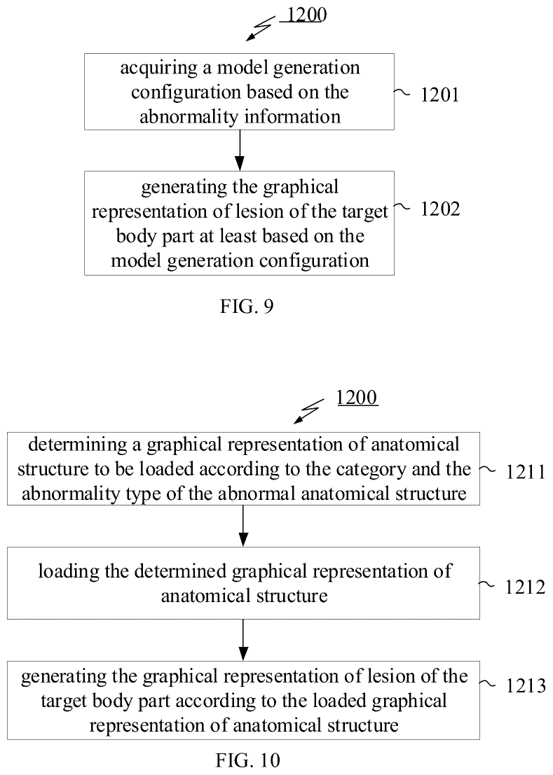

As shown in FIG. 9, in some embodiments, the generation of graphical representation of lesion based on the abnormality information of the target body part mentioned in step 1200 includes the following steps.

Step 1201: acquiring a configuration for generating graphical representation based on the abnormality information.

In some embodiments, the configuration for generating graphical representation includes a first configuration and/or a second configuration.

In some examples, the first configuration is used to represent a category and type of the graphical representation of anatomical structure associated with the abnormality information, such as representing a category and type of the graphical representation of anatomical structure associated with the abnormality information in the database for the target body part.

In some examples, the second configuration is used to represent a relative positional relationship of graphical representation of anatomical structures of respective categories in the first configuration (referring to the relative positional relationship in the target body part), for example, a stacking order of the graphical representation of anatomical structures of respective categories in the first configuration when generating the graphical representation of lesion.

In some examples, a plurality of different configuration for generating graphical representations are predetermined; and the acquisition of configuration for generating graphical representation based on the abnormality information may include: selecting one from the plurality of different configuration for generating graphical representations based on the abnormality information.

Step 1202: generating the graphical representation of lesion of the target body part at least based on the configuration for generating graphical representation. For example, the graphical representation of lesion of the target body part is generated based on the configuration for generating graphical representation and the graphical representation database.

As described above, the configuration for generating graphical representation includes a first configuration that represents the category and type of graphical representation of anatomical structures associated with the abnormality information. Accordingly, based on the first configuration, graphical representation of anatomical structure corresponding to the specified category and type of can be acquired. For example, in the exemplary scenario where the first configuration designates the category and type of graphical representation of anatomical structure associated with the abnormality information in the database for the target body part, the corresponding category and type of the graphical representation of anatomical structure may be selected from the graphical representation database based on the first configuration. It is understood that the categories and types of graphical representation of anatomical structures associated with abnormality information include at least the categories of graphical representation of abnormality anatomical structures and their specific pathological characteristics, thereby enabling precise selection of relevant graphical representations. For graphical representation of anatomical structures belonging to other categories within the defined target body part, only normal-type graphical representations are typically selected from these categories, as they are presumed to exhibit standard anatomical characteristics unless otherwise specified.

Furthermore, in some examples, different abnormality information may cause graphical representation of anatomical structures of the same category to occupy distinct positions within the target body part, that is, varying abnormality information can alter the relative positional relationships among graphical representation of anatomical structures across categories. Therefore, in addition to selecting graphical representation of anatomical structures of corresponding categories and types through the first configuration, a second configuration is required to determine the relative positional relationships between graphical representation of anatomical structures of different categories under the current abnormal condition.

Therefore, in some examples, the generation of a graphical representation of lesion of the target body part based on the configuration for generating graphical representation and the graphical representation database in step 1202 includes: selecting graphical representation of anatomical structures of corresponding categories and types from the graphical representation database based on the first configuration; and generating the graphical representation of lesion based on the selected graphical representation of anatomical structures, such as combining the selected graphical representation of anatomical structures according to the second configuration to generate the graphical representation of lesion.

As shown in FIG. 10, in some embodiments, the generation of a graphical representation of lesion based on the abnormality information of the target body part and using the graphical representation database for the target body part in step 1200 includes the following steps.

Step 1211: determining a graphical representation of anatomical structure to be loaded according to the category and the abnormality type of the abnormal anatomical structure.

Step 1212: loading the determined graphical representation of anatomical structure.

Step 1213: generating the graphical representation of lesion of the target body part according to the loaded graphical representation of anatomical structure.

Furthermore, in some examples, different abnormality information may cause graphical representation of anatomical structures of the same category to occupy distinct positions within the target body part—that is, varying abnormality information can alter the relative positional relationships between graphical representation of anatomical structures of different categories. Thus, when generating a graphical representation of lesion of the target region based on the loaded graphical representation of anatomical structures, the relative positional relationships between graphical representation of anatomical structures of different categories under the current abnormal condition are required to be utilized. Accordingly, in some examples, step 1211 further involves acquiring configuration item for graphical representations based on the abnormality information of the target body part (e.g., the category and abnormality type of an abnormal graphical representation of anatomical structures). These configuration item for graphical representations are used to represent the relative positional relationships of the loaded graphical representation of anatomical structures. In some examples, the relative positional relationships include the stacking order of the loaded graphical representation of anatomical structures. In some examples, at least two distinct abnormality types may result in differences in the aforementioned relative positional relationships (e.g., in stacking order). Here, the “at least two distinct abnormality types” may refer to: two abnormality types within the same category of graphical representation of anatomical structures, or one abnormality type each corresponding to graphical representation of anatomical structures of different categories. It is understood that graphical representation of anatomical structures of different categories inherently correspond to distinct abnormality types. The generation of the graphical representation of lesion of the target body part based on the loaded graphical representation of anatomical structure in step 1213 may include: combining the loaded graphical representation of anatomical structures according to the relative positional relationships specified in the configuration item for graphical representations to generate the graphical representation of lesion of the target body part.

The above provides explanations of Step 1200 that involves generating a graphical representation of lesion based on the abnormality information of the target body part and utilizing the graphical representation database for the target body part.

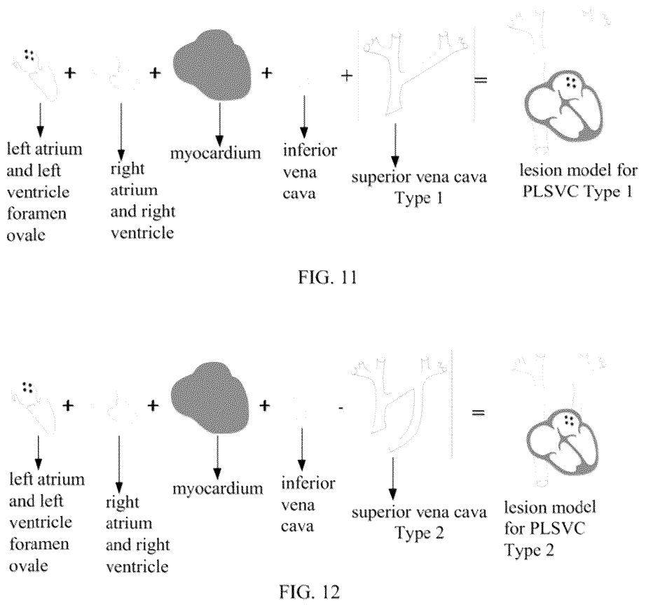

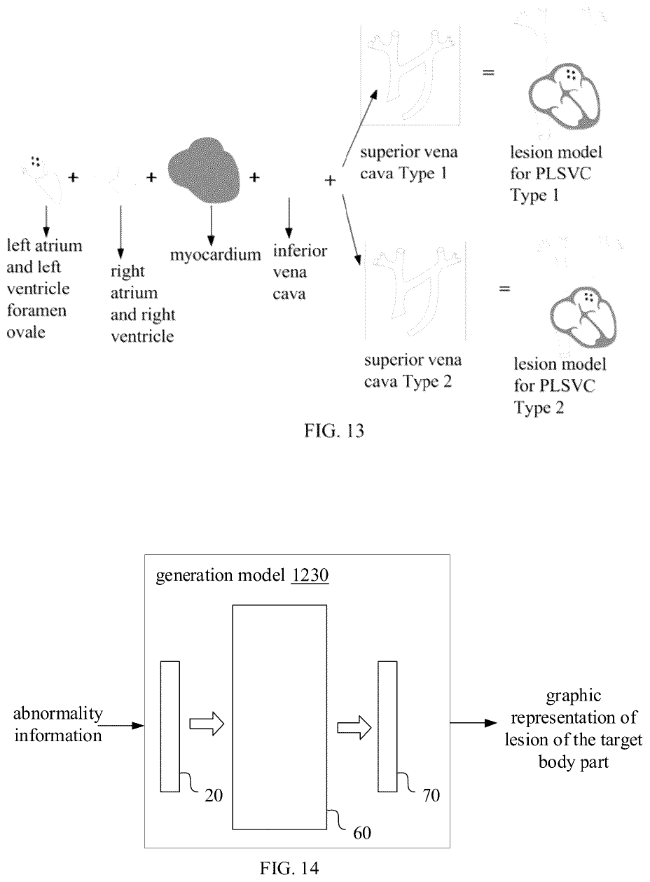

FIG. 11 illustrates an example of display of a graphical representation of lesion for persistent left superior vena cava (PLSVC) Type 1. If the abnormality information includes the lesion type of the target body part, the target lesion type for a heart/fetal heart is first acquired as PLSVC Type 1. If the abnormality information includes the category and abnormality type of an abnormal anatomical structure, the category of the abnormal anatomical structure is the left superior vena cava, and the abnormality type is Type 1. Consequently, the following graphical representation of anatomical structures are selected from the graphical representation database: graphical representation of left atrial, graphical representation of right atrial, graphical representation of left ventricular, graphical representation of right ventricular, graphical representation of foramen ovale, graphical representation of myocardial, graphical representation of inferior vena cava, and graphical representation of superior vena cava. Among these, the graphical representation of left atrial, graphical representation of right atrial, graphical representation of left ventricular, graphical representation of right ventricular, graphical representation of foramen ovale, graphical representation of myocardial, and graphical representation of inferior vena cava are normal type, while the graphical representation of superior vena cava is abnormal Type 1. By stacking these graphical representation of anatomical structures of specified categories and types, the graphical representation of lesion for PLSVC Type 1 is generated. Similarly, FIG. 12 illustrates an example of display of the graphical representation of lesion for PLSVC Type 2. If the abnormality information includes the lesion type of the target body part, the target lesion type for the heart/fetal heart is first acquired as PLSVC Type 2. If the abnormality information includes the category and abnormality type of an abnormal anatomical structure, the category of the abnormal anatomical structure is the left superior vena cava, and the abnormality type is Type 2. Consequently, the following graphical representation of anatomical structures are selected from the graphical representation database: graphical representation of left atrial, graphical representation of right atrial, graphical representation of left ventricular, graphical representation of right ventricular, graphical representation of foramen ovale, graphical representation of myocardial, graphical representation of inferior vena cava, and graphical representation of superior vena cava. Among these, the graphical representation of left atrial, graphical representation of right atrial, graphical representation of left ventricular, graphical representation of right ventricular, graphical representation of foramen ovale, graphical representation of myocardial, and graphical representation of inferior vena cava are normal type, while the graphical representation of superior vena cava is abnormal Type 2. By stacking these graphical representation of anatomical structures of specified categories and types, the graphical representation of lesion for PLSVC Type 2 is generated. As shown in FIG. 13, both Type 1 and Type 2 PLSVC graphical representation of lesions share the following structures: graphical representation of left atrial, graphical representation of right atrial, graphical representation of left ventricular, graphical representation of right ventricular, graphical representation of foramen ovale, graphical representation of myocardial, and graphical representation of inferior vena cava (all normal types). The distinction lies solely in the type of the graphical representation of superior vena cava. Thus, the method disclosed herein reduces modeling time while enhancing consistency between subtypes of graphical representations.

In some embodiments, Step 1200 involves inputting the abnormality information into a generation model 1230 to generate the graphical representation of lesion of the target body part, as detailed below.

As shown in FIG. 14, in some embodiments, the generation model 1230 comprises an input layer 50, an intermediate layer 60, and an output layer 70. The generation model 1230 receives the abnormality information via the input layer 50, extracts features on the abnormality information through the intermediate layer 60, generates the graphical representation of lesion of the target body part based on the extracted features, and outputs the graphical representation of lesion of the target body part through the output layer 70.

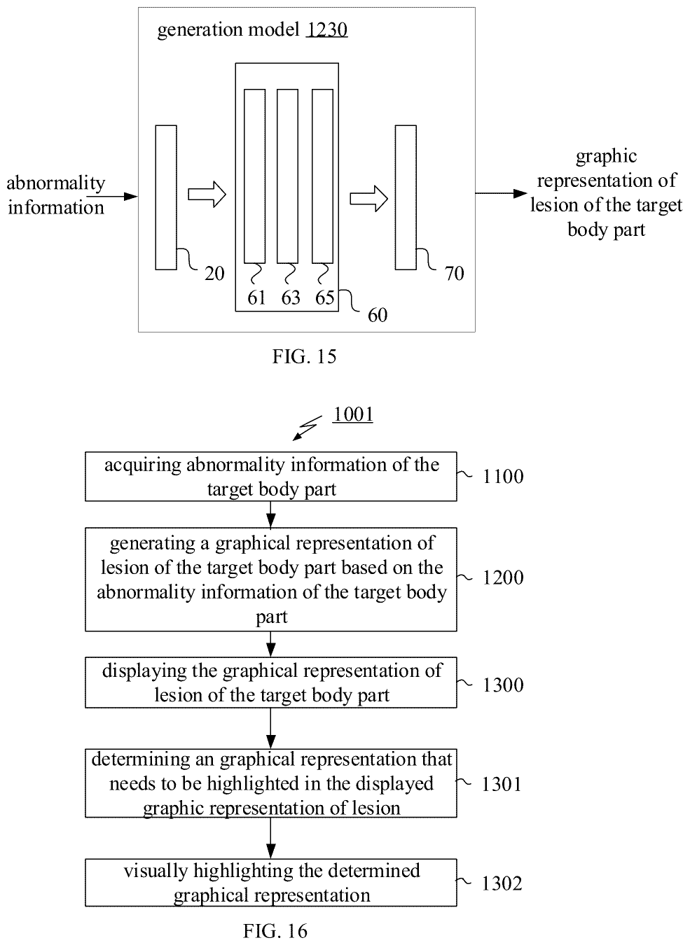

As shown in FIG. 15, in some examples, the intermediate layer 60 of the generation model 1230 includes a medical text encoding layer 61, a text-image mapping layer 63, and an image decoding layer 65. The medical text encoding layer 61 is configured to perform word segmentation on the inputted abnormality information, reorganize the segmented text to obtain sentence vectors, and map them into a high-dimensional text encoding spatial features. The text-image mapping layer 63 is configured to map the high-dimensional text encoding spatial feature from the text encoding space to an image encoding space, producing a high-dimensional image encoding spatial feature. The image decoding layer 65 is configured to perform image decoding the high-dimensional image encoding spatial feature to generate the graphical representation of lesion of the target body part.

In some examples, the generation model 1230 is a large language model

By inputting linguistic text describing abnormality information into the generation model 1230, which is implemented as a large language model, the graphical representation of lesion of the target body part is generated.

The core of the large language model utilizes collected graphical representation of lesions and corresponding abnormality information (e.g., lesion types of the target body part, diagnostic description text about the target body part, or the category and abnormality type of an abnormal anatomical structure) to construct training samples, fine-tuning the large language model through the training samples using a pre-trained large language model so as to enable said model to rapidly generate corresponding graphical representation of lesions based solely on abnormality information (e.g., the lesion type of the target body part, the diagnostic description text about the target body part, or the category and abnormality type of an abnormal anatomical structure). It is understood that: when the abnormality information includes the lesion type of the target body part, the input to the large language model is linguistic text describing the lesion type of the target body part; and when the abnormality information includes the category and abnormality type of an abnormal anatomical structure, the input to the large language model is linguistic text describing the category and abnormality type of an abnormal anatomical structure. In some examples, the large language model may be selected from models such as the Gopher large language model, LLAMA large language model, GLM-130B large language model, or PaLM large language model.

The large language model fundamentally falls within the domain of AI-generated content (AIGC). Its network architecture primarily comprises convolutional layers, pooling layers, activation layers, and fully connected layers. By combining and stacking these distinct layers to form modules such as transformer or UNet, the model learns features from training samples. Accordingly, in some examples: the medical text encoding layer 61 may be implemented using models such as Byte-Pair Encoding (BPE) networks, WordPiece networks, UniLM networks, or CLIP networks; the text-image mapping layer 63 may be implemented using generative adversarial networks (GANs) or diffusion models; the image decoding layer 65 may be implemented using autoencoder (AE) models or variational autoencoder (VAE) models.

The above provides structural explanations of the generation model 1230.

In some embodiments, the generation model 1230 is trained via fine-tuning to update some parameters within the generation model 1230.

Network fine-tuning aims to train a large-scale model with billions or tens of billions of parameters using limited training samples. For the original pre-trained model parameters, two common fine-tuning approaches are typically employed: one is full-parameter fine-tuning, and the other is efficient parameter fine-tuning. In the full-parameter fine-tuning, the pre-trained model undergoes continuing training on a specialized training dataset with all parameters being updated synchronously. In the efficient parameter fine-tuning: only a portion of parameters is updated or structural constraints such as sparsification or low-rank approximation is utilized, which includes, but is not limited to: reparameterization techniques (e.g., the LoRA series), partial parameter updates (e.g., BitFit), introduction of additional parameters (e.g., Prompt Tuning, ControlNet).

In some embodiments, the generation model 1230 is trained through the following steps:
(1) First training only on the medical text encoding layer 61: The medical text encoding layer 61 is fine-tuned using inputted abnormality information;
(2) Second training only on the text-to-image mapping layer 63: The text-image mapping layer 63 is trained with a text-image pair comprising abnormality information and a corresponding graphical representation of lesion;
(3) Third training only on the image decoding layer 65: The image decoding layer 65, mapping from an image encoding space to a graphical representation of lesion, is trained;
(4) The medical text encoding layer 61 after the first training, the text-image mapping layer 63 after the second training, and the image decoding layer 65 after the third training are combined to form the intermediate layer 60; and
(5) Fourth training on the intermediate layer 60: The combined intermediate layer 60 undergoes fine-tuning to map abnormality information to a graphical representation of lesion.

The above steps correspond to the generation of the graphical representation of lesion of the target body part by inputting the abnormality information into the generation model 1230 in step 1200. In some embodiments, the generated graphical representation of lesion may include multiple editable graphical representation of anatomical structures that can be individually modified under an editing instruction.

After the generation of the graphical representation of lesion of the target body part in step 1200, the generated graphical representation of lesion can be fine-tuned based on ultrasound data of the target body part. For example, the ultrasound data of the target body part may be acquired; deformation metrics of the graphical representation of lesion may be calculated based on the ultrasound data of the target body part and the graphical representation of lesion; and the graphical representation of lesion may be deformed using the deformation metrics, thereby obtaining a deformed graphical representation of lesion.

Step 1300: displaying the graphical representation of lesion of the target body part.

As shown in FIG. 16, the method 1001 for generating a graphical representation of lesion of a target body part in some embodiments may further include:

Step 1301: determining a graphical representation of anatomical structure that needs to be highlighted in the displayed graphical representation of lesion; and

Step 1302: visually highlighting the determined graphical representation of anatomical structure. Structural highlighting may enable highlighting of one or more graphical representation of anatomical structures within the graphical representation of lesion.

The above describes the process for generating and displaying the graphical representation of lesion of the target body part. Certain examples of the present disclosure, including the disclosed method for generating a graphical representation of lesion of a target body part and apparatus, establish a novel communication bridge between medical professionals (e.g., sonographers, clinicians) and patients, thereby improving the accuracy of disease characterization (e.g., congenital heart disease (CHD)).

In some examples, the generated graphical representation of lesion of the target body part can be edited by users, for example, the graphical representation of anatomical structure can be added, deleted, and/or adjusted. This capability significantly enhances the applicability of the graphical representation of lesion. In implementations utilizing a graphical representation database to generate a graphical representation of lesion, the proposed method can reduce both the data volume and complexity of the graphical representation database for the target body part. In implementations employing a generation model to generate a graphical representation of lesion, the method can reduce the training burden and architectural complexity of the generation model.

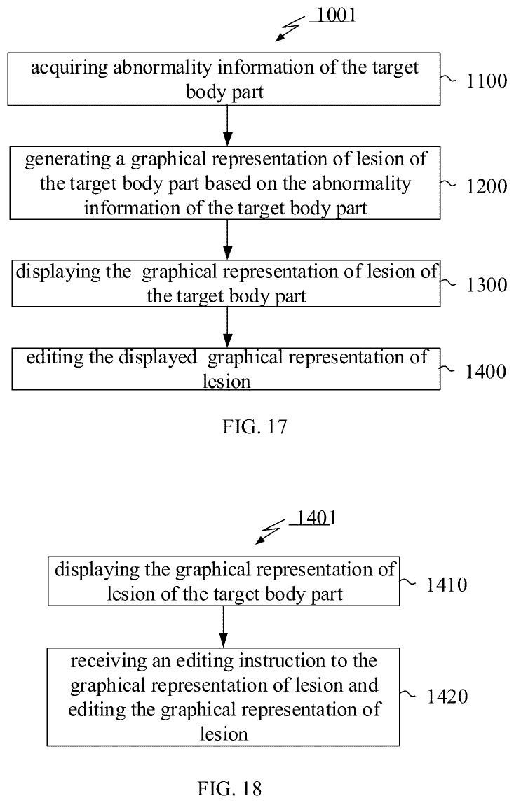

Thus, as shown in FIG. 17, the graphical representation of lesion generation method 1001 in some embodiments further includes step 1400 that involves editing the displayed graphical representation of lesion. For example, in step 1400, the graphical representation of lesion may be edited in response to an editing instruction applied to the displayed graphical representation of lesion.

For a more detailed description of step 1400 (editing the displayed graphical representation of lesion), reference may be made to the editing method 1401 for the graphical representation of lesion of the target body part disclosed herein, details of which are omitted for brevity.

Referring to FIG. 18, a method 1401 for editing the graphical representation of lesion of the target body part provided in some embodiments may comprise the following steps:

Step 1410: displaying the graphical representation of lesion of the target body part.

In some examples, the graphical representation of lesion displayed in Step 1410 (or subject to editing) may be generated by the graphical representation of lesion generation method 1001 disclosed herein.

Step 1420: receiving an editing instruction directed to the graphical representation of lesion and editing the graphical representation of lesion.

The graphical representation of lesion is edited in units of graphical representation of anatomical structures. For example, a user operates the graphical representation of lesion through an input device (such as a mouse) to select the to-be-edited graphical representation of anatomical structure. Based on the category of the selected to-be-edited graphical representation of anatomical structure, the system displays editing items contained in the corresponding category of graphical representation of anatomical structure. The graphical representation of anatomical structures of different categories can have distinct editable contents—for instance, atrial/graphical representation of ventriculars may have adjustable wall thickness parameters, while graphical representation of tumors may have adjustable size and orientation parameters. The user then performs operations through the displayed editing items specific to the corresponding category of graphical representation of anatomical structure to edit the graphical representation of anatomical structure of that particular category.

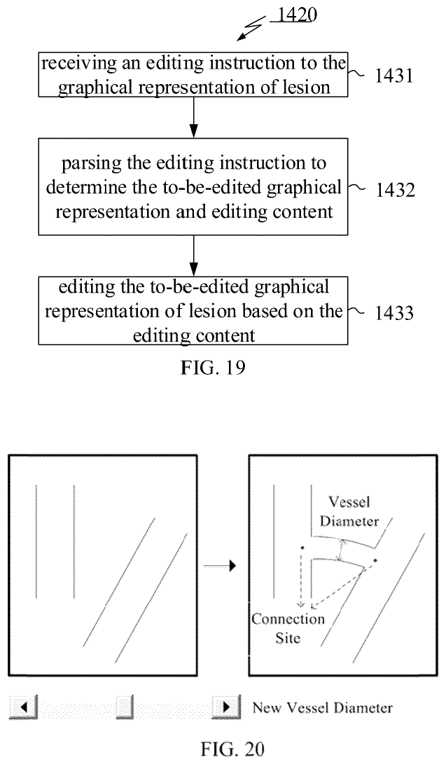

As shown in FIG. 19, in some embodiments, the editing of the graphical representation of lesion upon receiving an editing instruction to the graphical representation of lesion in step 1420 may include the following steps:

Step 1431: receiving an editing instruction to the graphical representation of lesion;

Step 1432: parsing the editing instruction to determine the to-be-edited graphical representation of anatomical structure and editing content; and

Step 1433: editing the to-be-edited graphical representation of anatomical structure based on the editing content.

In some embodiments, the editing of the graphical representation of lesion in step 1420 comprises at least one of the following:
(1) Adding one or more graphical representation of anatomical structures to the graphical representation of lesion.

For example, when the target body part includes a fetal heart or heart, the addition of graphical representation of anatomical structures to the graphical representation of lesion comprises at least one of: adding a graphical representation of vascular branch to the graphical representation of lesion, adding a graphical representation of bridging vessel to the graphical representation of lesion, adding a graphical representation of tumor to the graphical representation of lesion, or adding a graphical representation of defect to the graphical representation of lesion. In some exemplary embodiments, the added graphical representation of anatomical structure in the graphical representation of lesion is obtained from a graphical representation database for the target body part; said graphical representation database comprises one or more graphical representation of anatomical structures of different categories, each category corresponding to a category of anatomical structure of the target body part. In some examples, at least one category of graphical representation of anatomical structures includes a plurality of graphical representation of anatomical structures of a same category but different types. In some cases, different types at least comprise two types, such as at least two abnormality types, or, a normal type and at least one abnormality type.

In some embodiments, one or more graphical representation of anatomical structures of different categories in the graphical representation database comprises one or more basic category graphical representation of anatomical structures. In some exemplary embodiments, the basic category graphical representation of anatomical structures are configured to define a complete graphical representation of anatomical structure of the target body part. In some examples, at least one basic category graphical representation of anatomical structures comprises a plurality of graphical representation of anatomical structures of a same category but different types. In some examples, different types at least include two types, such as at least two abnormality types, or, a normal type and at least one abnormality type.
(2) Deleting one or more graphical representation of anatomical structures contained in the graphical representation of lesion.
(3) Editing morphological characteristics and/or spatial positioning of one or more graphical representation of anatomical structures contained within the graphical representation of lesion.

For example, when the target body part includes a fetal heart or heart, the editing of morphological characteristics and/or spatial positioning of one or more graphical representation of anatomical structures contained in the graphical representation of lesion comprises at least one of: adjusting the diameter of an entire or partial graphical representation of vessel in the graphical representation of lesion; modifying the dimension, position, and/or orientation vectors of a graphical representation of tumor in the graphical representation of lesion; rescaling the volumetric parameters of an atrial graphical representation of chamber or a ventricular graphical representation of chamber in the graphical representation of lesion; calibrating wall thickness of an atrial graphical representation of chamber or a ventricular graphical representation of chamber in the graphical representation of lesion; altering the dimensional specifications of an graphical representation of arterial valve in the graphical representation of lesion; adjusting the opening size of a graphical representation of mitral valve or graphical representation of tricuspid valve in the graphical representation of lesion; modifying the thickness of a graphical representation of mitral valve or graphical representation of tricuspid valve in the graphical representation of lesion; refining the thickness of an graphical representation of arterial cone in the graphical representation of lesion; and reordering the stacking order of the graphical representation of anatomical structures within the graphical representation of lesion.

The following detailed description references the accompanying drawings to illustrate embodiments where the heart or fetal heart serves as the target body part.

### (1) Editing of a Newly Added Graphical Representation of Vessel.

A newly added blood vessels may include a newly added graphical representation of bridging vessel and/or a newly added graphical representation of vascular branch. The newly added graphical representation of bridging vessel refers to a newly added graphical representation of vessel that connects two existing graphical representation of vessels in the graphical representation of lesion. The newly added graphical representation of vascular branch refers to a graphical representation of separate vascular bifurcation that branches off from an existing graphical representation of vessel in the graphical representation of lesion.

FIG. 20 illustrates an example of adding a graphical representation of bridging vessel, which primarily involves the following steps:
determining connection positions between two graphical representation of vessels in the graphical representation of lesion, for example, by clicking on positions on the two graphical representation of vessels respectively to determine the connection position for each graphical representation of vessel;
(additionally) determining which side of the vessel wall the newly added graphical representation of vessel is connected to by using the connection position on the graphical representation of vessel; and specifically, when a connection position is determined by clicking on a position on one of the graphical representation of vessels, it is judged on which side wall of the currently clicked vessel the new graphical representation of vessel is connected;
based on the determination of which side wall of the original graphical representation of vessel the new graphical representation of vessel is connected to, as well as the determined connection positions of the two graphical representation of vessels, establishing a connection path of the new graphical representation of vessel; and
based on the connection path of the new graphical representation of vessel, adding a corresponding graphical representation of vessel to the graphical representation of lesion, wherein the method used to determine the connection path can be solved through interpolation methods, including spline interpolation or Lagrange interpolation, which are not exhaustively listed here.

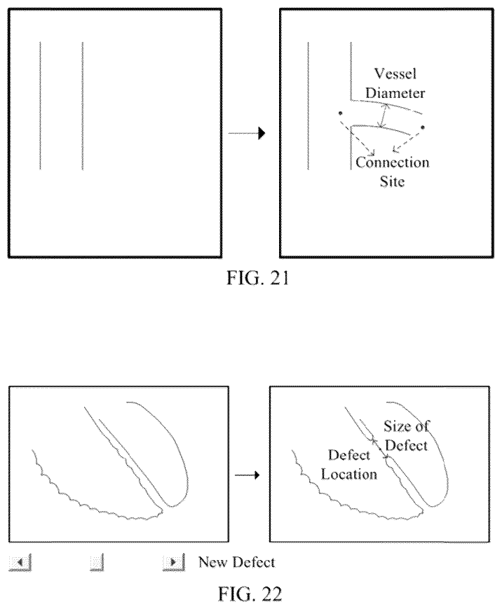

FIG. 21 illustrates an example of adding a graphical representation of vascular branch, which primarily involves the following steps:
determining a graphical representation of vessel to be branched and the location of the vessel branch; for instance, by clicking on a position on a graphical representation of vessel to determine that graphical representation of vessel as the graphical representation of vessel to be branched, the clicked position on the graphical representation of vessel being determined as the vessel branch location;
determining a direction of the graphical representation of vessel branch by clicking on a blank region;
(additionally,) determining which side wall of the graphical representation of vessel the graphical representation of vessel branch is located by evaluating the vessel branch position on the vessel; and specifically, when the graphical representation of vessel to be branched and the vessel branch position are determined by clicking on a position on the graphical representation of vessel, it is judged on which side wall of the currently clicked graphical representation of vessel the new graphical representation of vessel branch will be connected;
based on the determination of which side wall of the original graphical representation of vessel the new graphical representation of vessel branch is connected to, as well as the vessel branch position and the clicked blank region, determining a connection path of the new graphical representation of vessel branch; and
based on the connection path of the new graphical representation of vessel branch, adding a corresponding graphical representation of vessel branch to the graphical representation of lesion, wherein the method used to determine the connection path can be solved through interpolation methods, including spline interpolation or Lagrange interpolation, which are not exhaustively listed here.

It can be seen that whether it is adding a bridging vessel branch or a graphical representation of vessel branch, the essence is the addition of a new graphical representation of vessel. Therefore, from the perspective of user operation, users only need to determine two positions:
for adding a graphical representation of bridging vessel, the connection positions on the two graphical representation of vessels are determined; and
for adding a graphical representation of vessel branch, the vessel branch position on one graphical representation of vessel and another position for the graphical representation of vessel branch (the position of the clicked blank region mentioned above) are determined.

In this way, users only need to click two positions, a first position and a second position, using tools such as a mouse; then the apparatus will add a new vessel based on these two positions.

Moreover, for both an original graphical representation of vessel and a newly added graphical representation of vessels, users can also edit the diameter of the graphical representation of vessel. For instance, sliders or knobs can be provided to change the diameter of the newly added graphical representation of vessel. In an example, after selecting one or more graphical representation of vessels by a user, the apparatus can adjust the diameter of the selected graphical representation of vessel based on an operation instruction from a diameter editing control (such as a slider control or a knob control), making them thicker or thinner. This will be further explained below.

### (2) Editing of a Newly Added Graphical Representation of Defect.

A newly added defect includes, but is not limited to, a newly added ventricular septal graphical representation of defect, a newly added atrial septal graphical representation of defect, and a newly added atrioventricular septal graphical representation of defect. FIG. 22 illustrates an example of adding a new graphical representation of defect, which mainly comprises the following steps:
determining the location of a new graphical representation of defect; for instance, clicking on the atrial septum for a new atrial septal graphical representation of defect, or clicking on the ventricular septum for a new ventricular septal graphical representation of defect; and
adding the graphical representation of defect and placing it above two adjacent structures (which include but are not limited to graphical representation of atria and graphical representation of ventricle).

The purpose of adding a new graphical representation of defect is to establish a connection between the two graphical representations by introducing a graphical representation of defect.

Furthermore, for both an original graphical representation of defect and a newly added graphical representation of defect, users can also edit the size (dimension) of the graphical representation of defect. In an example, after selecting one or more graphical representation of defects by a user, the apparatus can adjust the size of the selected graphical representation of defect larger or smaller based on an operation instruction from a size editing control (such as a slider control or a knob control). This will be further explained below.

### (3) Editing of a Newly Added Graphical Representation of Tumor.

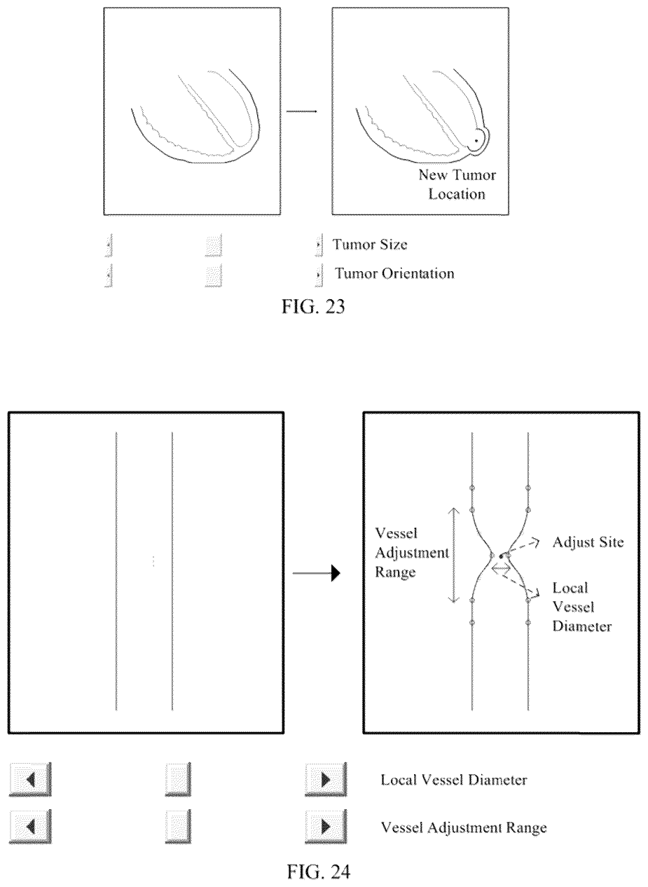

A newly added graphical representation of tumor includes but is not limited to a newly added graphical representation of ventricular aneurysm, a newly added graphical representation of atrial tumor, and a newly added graphical representation of rhabdomyoma. FIG. 23 illustrates an example of adding a new graphical representation of tumor, which mainly involves the following steps:
determining the location of a newly added graphical representation of tumor; for instance, selecting the location of the newly added graphical representation of tumor by clicking by a user, such as clicking on the graphical representation of ventricle for a new graphical representation of ventricular aneurysm or clicking on the atrium for a new graphical representation of atrial tumor; and
adding the graphical representation of tumor and placing it at the determined location of the new graphical representation of tumor.

The purpose of adding a new graphical representation of tumor is to generate a graphical representation of lesion for such as a cardiac chamber bulging lesion or heart tumor.

Furthermore, for both an original graphical representation of tumor and a newly added one, users can also edit the size and/or orientation of the graphical representation of tumor. In an example, after selecting a graphical representation of tumor by a user, the apparatus can enlarge or reduce the size of the selected graphical representation of tumor based on an operation instruction from a size editing control (e.g., a slider control or a knob control). Additionally, the apparatus can rotate the selected graphical representation of tumor clockwise or counterclockwise around its center based on an operation instruction from an orientation editing control (e.g., a slider control or a knob control). This will be further explained below.

### (4) Editing of a Local Graphical Representation of Vessel Diameter (Short for the Diameter of a Local Graphical Representation of Vessel).

The editing of local graphical representation of vessel diameter primarily focuses on adjusting the diameter (narrowing or widening) of a local region within a graphical representation of vessel. FIG. 24 illustrates an example of editing local graphical representation of vessel diameter, which may mainly comprise the following steps:
determining a local graphical representation of vessel to be edited (or a local region in a graphical representation of vessel), or determining a to-be-edited graphical representation of vessel and its to-be-edited local position; specifically, a user can determine this/these by clicking on a position on the graphical representation of vessel. Examples of graphical representation of vessels include, but are not limited to, the graphical representation of aorta, graphical representation of pulmonary artery, graphical representation of superior vena cava, and graphical representation of pulmonary vein.
adjusting the local diameter of the graphical representation of vessel through operation instructions from a (graphical representation of blood vessel) local diameter editing control (such as a slider control or knob control). Additionally, a local range editing control (such as a slider control or knob control) may be employed to modify the size of the local region within the graphical representation of blood vessel to be edited.

In an example, the local range editing control is used to smooth the transition range after the blood vessel diameter change, with a larger editing range resulting in a smoother transition. A specific implementation process is as follows: on the graphical representation of vessel walls corresponding to the position clicked, a plurality of equidistant points (e.g., seven points labeled p1 to p7) are selected on each side of the graphical representation of vessel wall. Here, p4 represents the point on the blood vessel wall closest to the position clicked on the blood vessel (i.e., the midpoint of p1-p7). The point p4 and its counterpart on the opposite wall are adjusted along their connecting line to narrow or widen the blood vessel. Points p3 and p5 on each side are adjusted to one-third of the displacement applied to p4, while the remaining points remain unchanged. Interpolation methods (e.g., spline interpolation) are then applied to refit the modified vessel contours, thereby achieving editing of local graphical representation of vessel diameter.

### (5) Editing of Overall Graphical Representation of Vessel Diameter

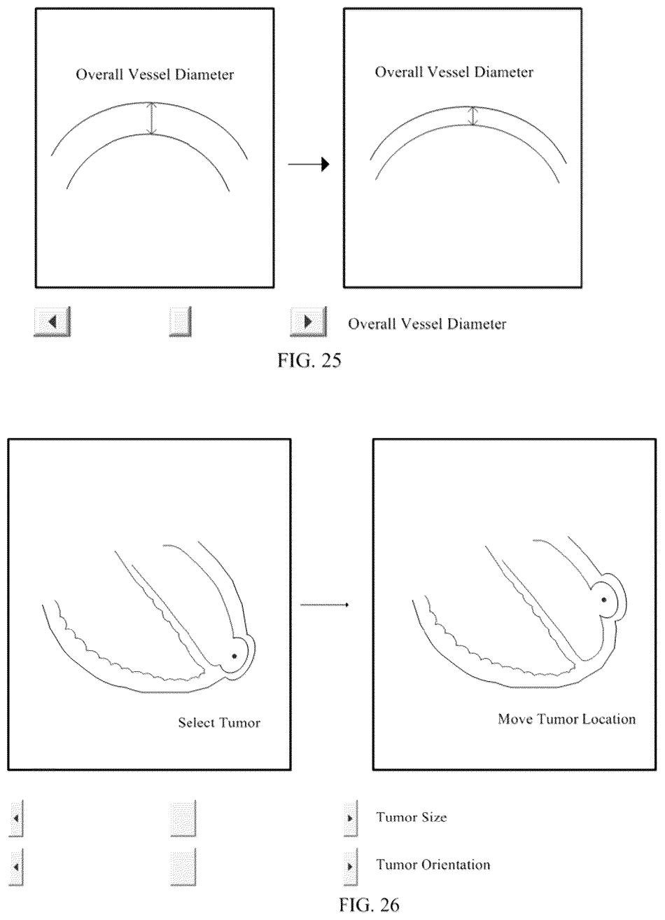

The editing of overall graphical representation of blood vessel diameter is primarily used to adjust the overall diameter (narrowing or widening) of a graphical representation of vessel. FIG. 25 illustrates an example of editing overall graphical representation of blood vessel diameter, which may mainly include the following steps:
determining a graphical representation of blood vessel to be edited: Users can select the graphical representation of blood vessel to be edited by clicking. In an example, graphical representation of blood vessels includes but are not limited to the graphical representation of aorta, graphical representation of pulmonary arteries, graphical representation of superior vena cava, graphical representation of pulmonary vein, etc.
editing the graphical representation of blood vessel diameter: After selecting one or more graphical representation of blood vessels by a user, the apparatus can adjust the thickness of the selected graphical representation of blood vessels based on an operation instruction from a diameter editing control (such as a slider control or a knob control), making them thicker or thinner. One possible implementation algorithm may involve calculating the nearest points from the discretized points located on one side of the blood vessel wall that is intended for movement, to their nearest points on the opposite blood vessel wall, and determining the movement direction and distance of a first point on the side of the blood vessel wall to be moved relative to its nearest point on the opposite blood vessel wall based on fine editing, thereby achieving the editing of the overall diameter of this graphical representation of blood vessel.

In some examples, during the overall diameter editing of a graphical representation of blood vessel, changes occur on both sides of the vessel, which may result in the concurrent adjustment of its connected anatomical graphical representation structures, such as other graphical representation of blood vessels, graphical representation of arterial valves, and graphical representation of arterial cones. For instance, the overall diameter editing of the main aortic graphical representation of blood vessel may require the concurrent adjustment of the descending graphical representation of aorta, graphical representation of aortic duct, and main aortic graphical representation of valve. Similarly, the overall diameter editing of pulmonary graphical representation of blood vessels may necessitate the concurrent adjustment of pulmonary graphical representation of arterial valves, graphical representation of arterial cones, and pulmonary blood graphical representation of vessel branches. Furthermore, the overall diameter editing of pulmonary blood graphical representation of vessel branches may require the concurrent adjustment of the main pulmonary graphical representation of blood vessel. In some examples, the adjusted graphical representation of blood vessels can be edited in diameter (e.g., proportionally becoming thicker or thinner) based on the diameter editing of the original graphical representation of blood vessel, while other non-vascular graphical representations can be proportionally enlarged or reduced.

### (6) Editing of Tumor Size, Location, and Orientation

Graphical representation of tumor editing mainly includes the modification of graphical representation of tumor size, location, and orientation. The types of graphical representation of tumor that can be edited include, but are not limited to, graphical representation of ventricular aneurysms, atrial appendage graphical representation of tumors, and graphical representation of rhabdomyomas. FIG. 26 illustrates an example of editing the graphical representation of tumor, which involves the following steps:
determining a graphical representation of tumor to be edited, for instance, by clicking on it for selection;
moving the graphical representation of tumor by dragging it to change its location;
resizing the selected graphical representation of tumor by using a size editing control (such as a slider control or a knob control) to make it larger or smaller;
rotating the selected graphical representation of tumor clockwise or counterclockwise around its center based on an operation instruction from an orientation editing control (such as a slider control or a knob control).

Moreover, the graphical representation of tumor editing process may be accompanied by changes in the lateral graphical representation of myocardium (for example, the editing processes of graphical representation of ventricular aneurysms and atrial appendage graphical representation of aneurysms may involve modifications to the adjacent graphical representation of myocardial).

### (7) Editing of the Size and Location of the Graphical Representation of Defect

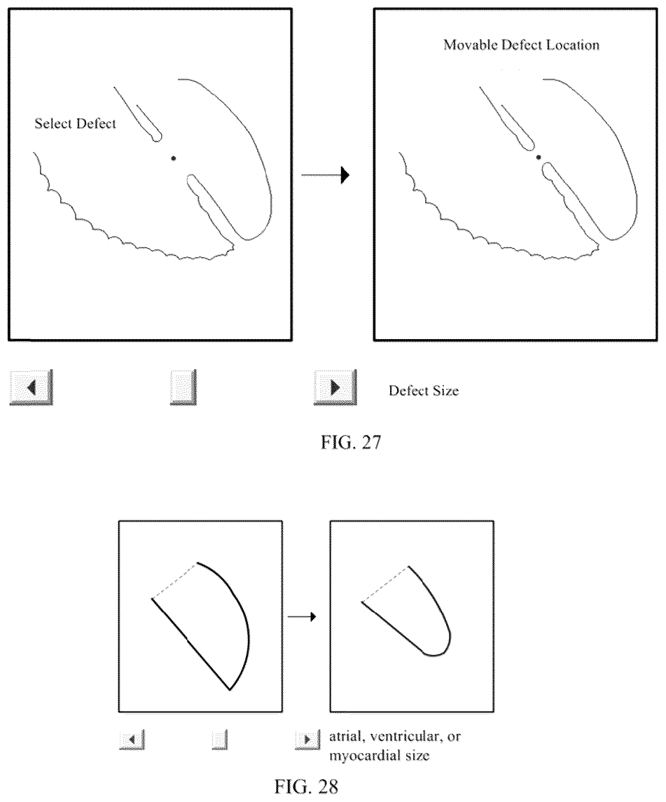

Graphical representation of defect editing primarily involves modifying the size and location of graphical representation of defects. The types of graphical representation of defect that can be edited include, but are not limited to, ventricular septal graphical representation of defects, atrial septal graphical representation of defects, and atrioventricular septal graphical representation of defects. FIG. 27 provides an example of graphical representation of defect editing, which mainly includes the following steps:
determining the graphical representation of defect to be edited, for instance, by clicking on it for selection;
moving the graphical representation of defect by dragging it to change its location; and
resizing the selected graphical representation of defect based on an operation instruction from a size editing control (such as a slider control or a knob control) to make it larger or smaller.

### (8) Editing of Graphical Representation of Atrial, Graphical Representation of Ventricular, and Ventricular Wall Thickness

The editing of graphical representation of atrial, graphical representation of ventricular, and ventricular wall thickness primarily used to modify the size of the graphical representation of atria, graphical representation of ventricle, and the thickness of the ventricular wall (myocardial size). FIG. 28 presents an example of this editing process, which mainly includes the following steps:
determining a graphical representation of atrial, graphical representation of ventricular, or myocardial structure to be edited, for instance, by clicking on it for selection; and
maintaining the fixed positions of the two endpoints and adjusting the distance between the structure's edge points and the line formed by these endpoints in a proportional manner. The size of the graphical representation may be altered by utilizing a slider or a knob.

Furthermore, due to the potential presence of graphical representation of defect such as a ventricular septal graphical representation of defect and atrial septal graphical representation of defect, consideration should be given to the concurrent editing of corresponding graphical representation of anatomical structure. Taking graphical representation of ventricular editing as an example, if a ventricular septal graphical representation of defect exists, the graphical representation of anatomical structure of the graphical representation of defect should be edited concurrently to ensure that the graphical representation of defect area fits seamlessly between the two graphical representation of ventriculars.

### (9) Editing of Size of Aortic Graphical Representation of Valve

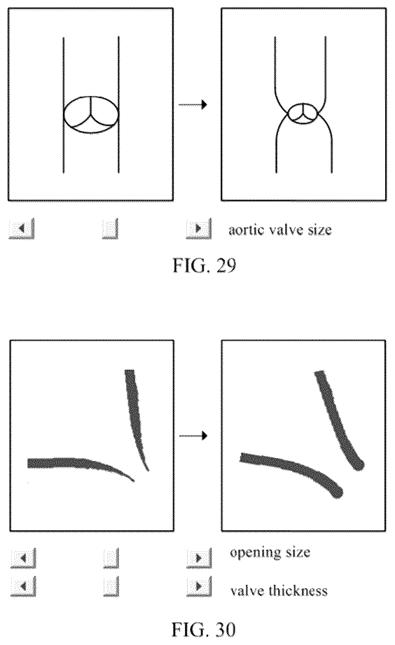

Graphical representation of arterial valve editing is primarily used to modify the size of the graphical representation of arterial valve and aortic graphical representation of valve. FIG. 29 illustrates an example of editing graphical representation of arterial valve, which may include the following steps:
determining an graphical representation of arterial valve (e.g., graphical representation of arterial valve or pulmonary graphical representation of valve) to be edited, for instance, by clicking on it for selection;
enlarging or shrinking the selected graphical representation of valve based on an operation instruction from a size editing control (such as a slider control or a knob control).

One possible implementation algorithm involves calculating the center of the elliptical graphical representation of arterial valve and scaling the entire graphical representation of arterial valve up or down from this center to achieve a desired size change.

Furthermore, the graphical representation of arterial valve, as a graphical representation of anatomical structure, is typically connected to a major artery above (the aortic graphical representation of valve connects to the graphical representation of aorta, and the pulmonary graphical representation of valve connects to the graphical representation of pulmonary artery). Below, it may be connected to a graphical representation of arterial cone. When changing the size of the graphical representation of arterial valve, it is essential to consider the concurrent editing of connected graphical representation of vessels to ensure the connectivity between different graphical representation of anatomical structures. The concurrent editing of related graphical representation of anatomical structures begins by altering the connection points with the graphical representation of arterial valve. Subsequently, to ensure a smooth transition between the connection points and the overall graphical representation of vessel, it is necessary to re-interpolate and generate the linked graphical representation of anatomical structure at regular intervals. Spline interpolation can be used as one of the interpolation methods.

### (10) Editing of the Mitral and Graphical Representation of Tricuspid Valve Opening Sizes and Thicknesses

The editing of the mitral and graphical representation of tricuspid valves primarily involves adjusting their opening sizes and thicknesses. FIG. 30 illustrates an example of mitral and graphical representation of tricuspid valves editing, which primarily includes the following steps:
determining the mitral or graphical representation of tricuspid valve to be edited, for instance, by clicking on it for selection;
increasing or decreasing the size of the opening of the selected mitral or graphical representation of tricuspid valve based on an operation instruction from an opening size editing control (such as a slider control or a knob control); and
increasing or decreasing the thickness of the selected mitral or graphical representation of tricuspid valve based on an operation instruction from a valve thickness editing control (such as a slider control or a knob control).

It should be understood that adjusting the opening size primarily modifies the distance between the valve cusps, effectively indicating whether the graphical representation of valve is stenotic. Additionally, altering the valve thickness changes the thickness of the valve cusps, simulating the thickening of the mitral and tricuspid valves. The opening size is determined by calculating the distance between the graphical representation of valve cusps; a greater distance indicates a larger opening. The editing process may involve using the line connecting the two graphical representation of valve cusps as the editing direction, allowing for a comprehensive adjustment of the opening size through holistic editing.

### (11) Editing of the Thickness of a Graphical Representation of Arterial Cone

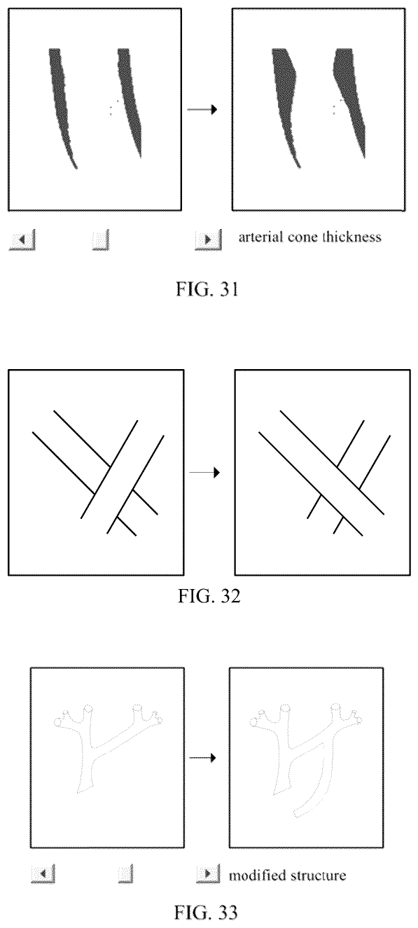

The editing of graphical representation of arterial cone is primarily used to adjust the local thickness of the graphical representation of arterial cone, thereby simulating muscular stenosis at the lower segment of the arterial valve. FIG. 31 illustrates an example of editing a graphical representation of arterial cone, which mainly involves the following steps:
determining the graphical representation of arterial cone to be edited, for instance, by clicking on it for selection;
increasing or decreasing the thickness of the graphical representation of arterial cone based on an operation instruction from an arterial cone thickness editing control (such as a slider control or a knob control). One specific process might involve highlighting the local region around the center of the graphical representation of arterial cone, with the center serving as the point of thickening, to achieve the desired change in thickness.

### (12) Editing of the Stacking Order of the Graphical Representation of Anatomical Structure

The editing of the stacking order of the graphical representation of anatomical structure is used to determine the stacking order of each graphical representation of anatomical structure within the graphical representation of lesion during superimposition. FIG. 32 illustrates an example of editing the stacking order, wherein the graphical representation of anatomical structure whose order is to be modified is selected, and subsequently, the graphical representation of anatomical structure positioned above the initially selected one is clicked on by the user, causing the order of the initially selected structure to be moved above the secondarily clicked structure, thereby achieving a change in the stacking order of the structures.

### (13) Replacement of Graphical Representation of Anatomical Structures

The replacement of graphical representation of anatomical structures is used to modify the structure of the graphical representation of lesion. It allows for the replacement of different morphologies of graphical representation of anatomical structures of the same category, which can be utilized to combine complex malformations. FIG. 33 illustrates an example of the replacement of graphical representation of anatomical structures, wherein, the graphical representation of anatomical structure to be replaced is selected first, and subsequently, other graphical representation of anatomical structures to replace the selected one are chosen through means such as a drop-down control.

### (14) Deletion of Graphical Representation of Anatomical Structure

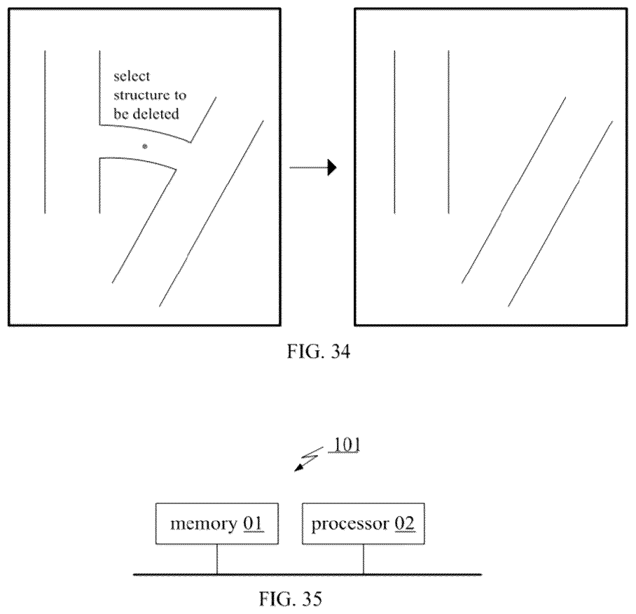

The deletion of a graphical representation of anatomical structure allows for the removal of any graphical representation of anatomical structure within the graphical representation of lesion, including but not limited to graphical representation of atria, graphical representation of ventricular, graphical representation of vessel, graphical representation of tumor, etc. FIG. 34 illustrates an example of the deletion of a graphical representation of anatomical structure. The process of deletion begins by selecting the graphical representation of anatomical structure to be deleted, and subsequently, the selected graphical representation of anatomical structure is deleted in response to a user's deletion command.

The above provides some explanations regarding the editing of graphical representation of lesions or, more specifically, graphical representation of anatomical structures.

In some embodiments, in step 1432, during parsing editing instruction to determine a graphical representation of anatomical structure to be edited and editing content, whether there are interconnected graphical representation of anatomical structures is also determined based on the to-be-edited graphical representation of anatomical structure and its editing content; when other interconnected graphical representation of anatomical structures are determined, their interconnected editing content is determined based on the to-be-edited graphical representation of anatomical structure and its editing content; and said other interconnected graphical representation of anatomical structures are edited based on the interconnected editing content. For example, during a global diameter adjustment of a graphical representation of blood vessel, if both ends of the graphical representation of vessel undergo modifications, edits may be automatically propagated to connected anatomical structures such as adjacent blood vessels, arterial valves, and conus arteriosus.

In some embodiments, upon receiving an editing instruction to the displayed graphical representation of lesion, the graphical representation of anatomical structure to be edited and editing content are determined; based on the to-be-edited graphical representation of anatomical structure and the editing content, the graphical representation of anatomical structure is edited based on corresponding editing content; and based on the to-be-edited graphical representation of anatomical structure and the editing content, an editing type is determined. The editing type comprises a non-interconnected editing type or an interconnected editing type. The non-interconnected editing type refers to modifications applied to the to-be-edited graphical representation of anatomical structure that do not propagate to other graphical representation of anatomical structures, thereby not requiring adaptive updates or edits to those graphical representations. The interconnected editing refers to modifications applied to the to-be-edited graphical representation of anatomical structure that propagate to other graphical representation of anatomical structures, thereby necessitating adaptive updates or edits to those graphical representations. Therefore, when the editing type is interconnected editing, interconnected graphical representation of anatomical structures and their interconnected editing parameters are determined based on the to-be-edited graphical representation of anatomical structure and its editing parameters, then applies these parameters to modify the interconnected graphical representations. For example, during a global diameter adjustment of a blood vessel, if modifications occur at both ends of the vessel, edits may be automatically propagated to connected anatomical structures such as adjacent blood vessels, arterial valves, and conus arteriosus.

Referring to FIG. 35, some embodiments further disclose an apparatus 101 for graphical representation of lesion of the target body part. The apparatus comprises: a memory 01 configured to store programs; a processor 02 configured to execute the programs stored in the memory 01 to implement the methods described in any of the embodiments herein, such as the graphical representation of lesion generation method 1001, the graphical representation of lesion editing method 1401, and similar methods.

In some embodiments, the processor 02 includes, but is not limited to, devices such as: a CPU; a MCU; an FPGA; and a DSP. These devices are configured to interpret computer instructions and process data in computer software.

This disclosure describes, with reference to various exemplary embodiments. However, Those skilled in the art will recognize that modifications and changes may be made to the exemplary embodiments without departing from the scope of this document. For instance, various operational steps, as well as the components used to execute these steps, may be implemented in different manners, taking into account specific applications or various cost functions related to system operation (e.g., one or more steps may be omitted, modified, or combined with other steps).

In the aforementioned embodiments, the implementation may be achieved, in whole or in part, through software, hardware, firmware, or any combination thereof. Additionally, as understood by those skilled in the art, the principles presented herein may be embodied in a computer program product reflected on a computer-readable storage medium, wherein the readable storage medium is pre-installed with computer-readable program code. Any tangible, non-transitory computer-readable storage medium may be utilized, including magnetic storage devices (hard disks, floppy disks, etc.), optical storage devices (CD-ROMs, DVDs, Blu-ray discs, etc.), flash memory, and/or the like. These computer program instructions can be loaded onto general-purpose computers, special-purpose computers, or other programmable data processing devices to form a machine, enabling the instructions executed on these computers or other programmable data processing devices to generate devices that perform specified functions. These computer program instructions can also be stored in a computer-readable memory, which can instruct a computer or other programmable data processing device to operate in a specific manner, such that the instructions stored in the computer-readable memory can form an article of manufacture, including an implementation device that realizes the specified functions. Furthermore, computer program instructions can be loaded onto a computer or other programmable data processing device, thereby executing a series of operational steps on the computer or other programmable device to produce a computer-implemented process. This allows the instructions executed on the computer or other programmable device to provide steps for realizing specified functions.

While the principles disclosed herein have been illustrated through various embodiments, it should be understood that structural configurations, material selections, and component proportions particularly suited to specific operational environments may be modified without departing from the scope and spirit of the disclosure. Such modifications, along with other adaptations or adjustments, shall be encompassed within the scope of the present disclosure.

The foregoing detailed description has been described with reference to various embodiments. However, those skilled in the art will recognize that modifications and variations may be made without departing from the scope of the disclosure. Accordingly, the description of the disclosure shall be interpreted in an illustrative rather than restrictive sense, and all such modifications are intended to be included within its scope. Similarly, discussions of advantages, alternative solutions to problems, and operational benefits associated with the embodiments are provided above. Nevertheless, benefits, advantages, solutions to problems, and any elements that may produce such effects or render them more explicit shall not be construed as critical, required, or essential. Furthermore, the term ‘coupled’ and its derivatives encompass physical connections (e.g., mechanical joints), electrical connections (e.g., circuit interconnects), magnetic linkages (e.g., inductive coupling), optical interfaces (e.g., fiber-optic alignment), communication channels (e.g., wireless protocols), functional integrations (e.g., software APIs), and any other form of association that achieves operational interaction.

Those skilled in the art will recognize that numerous modifications to the details of the above-described embodiments may be made without departing from the fundamental principles of the disclosed subject matter. Accordingly, the scope of the present disclosure shall be determined solely by the claims and their legal equivalents.

1. A method for generating a graphical representation of lesion of a target body part, comprising:
acquiring a category and an abnormality type of an abnormal anatomical structure in the target body part;
determining a graphical representation of anatomical structure to be loaded according to the category and the abnormality type of the abnormal anatomical structure;
loading the determined graphical representation of anatomical structure;
generating the graphical representation of lesion of the target body part according to the loaded graphical representation of anatomical structure; and
displaying the generated graphical representation of lesion of the target body part.

2. The method of claim 1, wherein said acquiring a category and an abnormality type of an abnormal anatomical structure in the target body part comprises:
displaying an abnormality selection interface for an anatomical structure of the target body part; and
determining the category and the abnormality type of the abnormal anatomical structure of the target body part in response to a user operation on the abnormality selection interface.

3. The method of claim 2, wherein
the abnormality selection interface comprises a plurality of anatomical structure selection items, each anatomical structure selection item corresponding to an anatomical structure of one category and comprising a category name of the anatomical structure and at least two types for selection; or,
the abnormality selection interface comprises a first quantity of single-malformation selection items and a second quantity of combined-malformation selection items.

4. The method of claim 1, wherein said acquiring a category and an abnormality type of an abnormal anatomical structure in the target body part comprises:
displaying an input interface;
acquiring a diagnostic description text regarding the target body part in response to a user input entered through the input interface; and
inputting the diagnostic description text into a text comprehension model to obtain the category and the abnormality type of the abnormal anatomical structure through the processing of the text comprehension model on the diagnostic description text.

5. The method of claim 1, wherein determining the graphical representation of anatomical structure to be loaded according to the category and the abnormality type of the abnormal anatomical structure comprises: determining the graphical representation of anatomical structure to be loaded in a graphical representation database, wherein,
the graphical representation database comprises a plurality of graphical representation of anatomical structures of different categories, each category of graphical representation of anatomical structure corresponding to a respective category of anatomical structure of the target body part; and
at least one category of graphical representation of anatomical structures comprises a plurality of graphical representation of anatomical structures with a same category but different types, wherein said types at least comprises a normal type and at least one abnormality type, or at least comprises two abnormality types.

6. The method of claim 5, wherein the plurality of graphical representation of anatomical structures of different categories in the graphical representation database comprises: one or more graphical representations of anatomical structures of basic category for defining a complete graphical representation of anatomical structure of the target body part, wherein
at least one graphical representation of anatomical structure of basic category comprises a plurality of graphical representation of anatomical structures with a same category but different types.

7. The method of claim 6, wherein
the target body part comprises a fetal heart or heart, and the graphical representation of anatomical structure of the basic category comprises at least one of: a graphical representation of chamber, a graphical representation of myocardium, a graphical representation of arterial vessel, a graphical representation of valve, and a graphical representation of venous vessel; or
the target body part comprises a blood vessel, and the graphical representation of anatomical structure of the basic category comprises at least one of: a graphical representation of coronary artery, a graphical representation of carotid artery, a graphical representation of abdominal aorta, and a graphical representation of superficial vein.

8. The method of claim 6, wherein the plurality of graphical representation of anatomical structures of different categories in the graphical representation database further comprises: at least one graphical representation of anatomical structure of special category that corresponds to an anatomical structure absent in a normal non-lesioned state of the target body part.

9. The method of claim 8, wherein
the target body part comprises a fetal heart or heart, and the graphical representation of anatomical structure of special category comprises at least one of: a graphical representation of defect, a graphical representation of foramen ovale, and a graphical representation of tumor; or
the target body part comprises a blood vessel, and the graphical representation of anatomical structure of special category comprises at least one of: a graphical representation of plaque, a graphical representation of aneurysm, and a graphical representation of embolism.

10. The method of claim 1, further comprising:
acquiring a configuration item for graphical representation based on the category and the abnormality type of the abnormal anatomical structure, wherein the configuration item for graphical representation is configured to represent a relative positional relationship between the loaded graphical representations of anatomical structure;
wherein said generating a graphical representation of lesion of the target body part according to the loaded graphical representation of anatomical structure comprises: combining the loaded graphical representation of anatomical structure according to the configuration item for graphical representation to generate the graphical representation of lesion of the target body part.

11. The method of claim 10, wherein the relative positional relationship comprises a stacking order of the loaded graphical representation of anatomical structures.

12. The method of claim 1, further comprising:
acquiring ultrasound data of the target body part;
calculating deformation metrics of the graphical representation of lesion according to the ultrasound data of the target body part and the graphical representation of lesion; and
deforming the graphical representation of lesion according to the deformation metrics to obtain a deformed graphical representation of lesion.

13. The method of claim 1, further comprising:
in response to an editing instruction to the displayed graphical representation of lesion, editing the graphical representation of lesion.

14. The method of claim 1, further comprising:
determining a graphical representation of anatomical structure in the displayed graphical representation of lesion; and
highlighting the determined graphical representation of anatomical structure.

15. A method for editing a graphical representation of lesion of a target body part, comprising:
displaying the graphical representation of lesion of the target body part, wherein the graphical representation of lesion comprises a plurality of graphical representation of anatomical structures that are editable individually; and
receiving an editing instruction to the graphical representation of lesion and editing the graphical representation of lesion.

16. The method of claim 15, wherein said receiving an editing instruction to the graphical representation of lesion and editing the graphical representation of lesion comprises:
receiving an editing instruction to the graphical representation of lesion;
parsing the editing instruction to determine a to-be-edited graphical representation of anatomical structure and an editing content; and
editing the to-be-edited graphical representation of anatomical structure based on the editing content.

17. The method of claim 15, wherein said editing the graphical representation of lesion comprises at least one of:
adding one or more graphical representation of anatomical structures in the graphical representation of lesion;
deleting one or more graphical representation of anatomical structures contained in the graphical representation of lesion; and
editing a morphology and/or position of one or more graphical representation of anatomical structures contained in the graphical representation of lesion.

18. The method of claim 15, wherein said receiving an editing instruction to the graphical representation of lesion and editing the graphical representation of lesion comprises:
receiving a selection instruction for selecting a graphical representation of anatomical structure in the graphical representation of lesion;
determining a target graphical representation of anatomical structure to be adjusted in the graphical representation of lesion according to the received selection instruction;
receiving an adjustment instruction; and
adjusting at least one of a position, a shape, a size, a direction and a thickness of the target graphical representation of anatomical structure to be adjusted according to the adjustment instruction.

19. An apparatus for generating a graphical representation of lesion of a target body part, comprising:
a memory for storing a program; and
a processor for executing the program stored in the memory to:
acquire a category and an abnormality type of an abnormal anatomical structure in the target body part;
determine a graphical representation of anatomical structure to be loaded according to the category and the abnormality type of the abnormal anatomical structure;
load the determined graphical representation of anatomical structure;
generate the graphical representation of lesion of the target body part according to the loaded graphical representation of anatomical structure; and
display the generated graphical representation of lesion of the target body part.
